(19) United States
(12) Patent Application Publication
(10) Pub. No.: US 2002/0089927 A1
(43) Pub. Date: Jul. 11, 2002

(54) System and method for synchronizing data trasnmission across a variable delay interface

(76) Inventors: Michael A. Fischer, San Antonio, TX (US); David J. Leach, JR., San Antonio, TX (US); Jack B. Hughes, San Antonio, TX (US)

Correspondence Address: Gary Stanford, 610 West Lynn, Austin, TX, 78703, US

(21) Appl. No.: 09/849,053

(22) Filed: May 4, 2001

Related U.S. Application Data
(60) Provisional application No. 60/261,436, filed on Jan. 11, 2001.

(51) Int. Cl. H04J 3/14

(52) U.S. Cl. 370/229; 370/428

(57) ABSTRACT

A method of synchronizing data transmission between a host computer system and a transmitter across an interface with variable delay or latency. The host computer system marks transition frames between successive transmission intervals and transfers the outgoing frames across the variable interface to the transmitter. The transmitter enqueues outgoing frames into one or more FIFO transmission queue(s) and processes the enqueued frames as appropriate for the communication protocol in use. Marked frames are detected as they reach the head of the appropriate transmit queue. In particular, while bypassing is not active, the transmitter transmits unmarked frames until the end of the current interval, or until there is insufficient time in the interval to transmit another frame or until a marked frame is detected. While bypassing is not active, the transmitter terminates transmission from the transmit queue when a marked frame is detected during each interval. While bypassing is active, the transmitter discards unmarked frames without transmission until a marked frame is detected. During each interval, the transmitter activates bypassing if a marked frame has not been detected and deactivates bypassing if a marked frame is detected while bypassing is active. The transmitter enables queue mark operation if a marked frame is detected while queue mark operation is not enabled. The transmitter increments a bypass counter each time an interval ends without detecting a marked frame, and disables queue mark operation if the bypass counter reaches a predefined limit.

### CROSS-REFERENCE TO RELATED APPLICATION(S)

The present application is based on U.S. Provisional Application entitled “System And Method For Synchronizing Data Transmission Across an Interface With Variable Timing”, Application No. 60/261,436 filed Jan. 11, 2001, which is hereby incorporated by reference in its entirety.

### FIELD OF THE INVENTION

The present invention relates to LAN communications, and more particularly to a system and method for synchronizing data transmission across a variable delay interface with indeterminate delay or latency.

### DESCRIPTION OF RELATED ART

Network communication is a growing area of technology, both for business and home applications. A network system enhances communication and provides a suitable environment for enhanced productivity and capabilities, both at home and in the workplace. It is becoming more advantageous and common for small businesses and home environments to include a local area network (LAN) that is connected to external networks, such as the Internet, that provides access to common databases and libraries and the like, and that enables communication between multiple devices that support various services, such as file sharing, printing, faxing, e-mail, voice-over-IP, video streaming, video conferencing, etc.

Many such small networks are connected through a set of wires. Wired networks are well known and generally have acceptable performance, but have many limitations, such as various cable management and convenience issues. For various reasons, wireless LAN (WLAN) technology is becoming more popular. Radio frequency (RF) appears to be the technology of choice for establishing a practical WLAN. The typical environment for wireless communications, however, is very noisy and not optimal for LAN communications. For example, most homes and work places include many electronic devices that transmit or emit RF energy resulting in an electronically noisy environment that may interfere with WLAN communications. Examples of such transmitters are microwave ovens, garage door openers and cordless telephones. Examples of unintentional emitters are radios, television sets, computer systems, etc. Further, the signal propagation characteristics of the communication medium between wireless devices constantly changes. For example, most indoor environments or rooms include multiple surfaces that are reflective to RF energy, creating multipath noise. Also, movement of items or devices or the like, such as hands, bodies, jewelry, mouse pointers, etc. or activation of electronic devices, such as cooling fans or the like, affects the overall wireless communication path and potentially degrades wireless communication performance. In summary, wireless communications must be made through a dynamic and unpredictable medium.

Wireless communications are problematic for various other reasons. The physical area served by a wireless network in not precisely defined due to the dynamic environment. In some environments, separate WLANs are proximally located which increases the likelihood for destructive interference between wireless devices that are not intended to communicate with each other. This is true because range at which WLAN radios interfere with each other is typically two to three times greater than the range at which they can reliably communicate. Power management is also an important consideration in wireless communication since wireless devices are often battery-powered. Typical solutions of increasing transmit power (or “RF power” or “radiated power”) or increasing clock speed that are often available in wired devices with ready access to utility power or the like is not usually available for wireless devices. It is not necessarily an option to decrease transmit power to reduce interference since this also reduces the communication area within a WLAN and reduces coverage faster than interference due to the square law.

Consumers are demanding high-speed wireless applications and relatively high quality of service (QoS) applications. Video applications, for example, consume four or more megabits per second (Mbps) of bandwidth. Audio applications are not as bandwidth intense, which require bandwidth on the order of 30 kilobits per second (Kbps). Nonetheless, audio applications still have many timing constraints and requirements. Audio information, for example, is very sensitive to jitter and latency variation, which if not properly addressed may result in a breakdown of communications or dissatisfied users at much lower levels at which the audio cannot be understood at all. This is particularly true for two-way communications, such as voice-over-IP and video conferencing where delay, latency and jitter issues must be addressed and resolved, which is especially difficult for wireless communications. In spite of the limited capabilities of wireless communication as compared to wired communication, consumers desire wireless devices that support these high speed timing critical applications.

The IEEE (Institute of Electrical and Electronics Engineers) 802.11-1999 standard (“the 802.11 standard”) is a protocol standard for wireless LANs. The present disclosure employs various concepts and terminology of the 802.11 standard for purposes of explanation and illustration of exemplary embodiments, although it is understood that the present invention is not limited to communications according to the 802.11 standard but instead is applicable to any communication architecture and protocol. The 802.11 standard focuses on the media access control (MAC) and physical (PHY) layer communication protocols. The basic intent of this standard is to establish communication via a wireless medium regardless of the configuration or implementation of the upper layers. In other words, the WLAN standard is an attempt to make lower communications transparent to the upper layers. Upper layer applications, however, were designed to communicate via success-oriented wired and/or optical fiber media.

Wired LANs, such as communications based on Ethernet 802.3, for example, are success-oriented and have relatively low delay and very low loss of data packets, whereas wireless communications are much less robust and have a substantially higher data loss rate. In particular, wired LANs communications typically lose less than one in one million or (1 in 10⁶) packets, whereas wireless communications based on 802.11 have a packet loss rate that is closer to one in one thousand (1 in 10³), or about three to four orders of magnitude higher loss rate as compared to wired LANs. Wired communications are much more predictable, with somewhat deterministic delays, whereas wireless communications exhibit significantly greater and less predictable delays. As used herein, the term “frame” generally denotes any type of link or physical layer data unit, and incorporates the concepts of a fixed- or variable-sized packet, cell, slot, protocol data unit (PDU), medium access control (MAC) PDU (MPDU), MAC management PDU (MMPDU), service data unit (SDU), MAC SDU (MSDU), or any other packetized means of communication.

Wired Ethernet communications use a collision detection method referred to as carrier sense multiple access with collision detection (CSMA/CD) for arbitrating access to the medium between two or more devices. Such collision detection methods are not practical in wireless communication since it is difficult for a wireless receiver to detect wireless transmission of another device while the local transmitter is operating. Wired Ethernet communications conduct retry and acknowledge functions at higher layers due to typical undetected frame loss rates of 10⁻⁶. In wireless LANs, because of network media which incur frame loss rates as high as 10⁻³, the retry and acknowledge functions have been incorporated into the MAC/PHY functions, and thereby consume valuable bandwidth for wireless communications. Wired communications require very little time to resolve a signal being sent. In contrast, for wireless transmissions, the receiver consumes a variable amount of valuable time to detect and resolve a signal being transmitted and to decode the information within the signal. For example, it is often necessary to measure the multipath and inter-symbol interference (ISI) distortion impact while receiving a known preamble and apply the measured distortion to the remaining packet payload in order to access the transmitted information. Valuable time may be needed to select among multiple antennas for the best signal, to set automatic gain control (AGC) levels, to synchronize the despreader, etc.

The problems with WLAN communications are compounded when implemented on personal computer (PC) platforms or the like commonly employed in home or small office environments. For example, mid- and high-layer protocol functions may be implemented using application and driver software running on a host processor, such as a central processing unit (CPU) of a PC or the like, whereas lower layer protocol functions may be implemented by firmware running on a MAC controller chip or the like mounted to an expansion board or card that is plugged into an expansion connector of the computer. This card also incorporates the physical layer (PHY) communication transceiver, such as a radio or the like, coupled between the MAC controller and one or more antennas. The variable interface between the layers above the MAC and the transceiver may include one or more input/output (I/O) buses and corresponding interface circuitry. It is imperative for proper operation that the higher layers communicate with the MAC/PHY transceiver in order to manage the information being transmitted. In the typical computer system or wireless access point (AP), a common communication mechanism between the higher layers and the transceiver is interrupt driven. Host processor interrupt latency, however, is variable, not readily determinable, and for the most part, uncontrollable by the wireless system including both the higher layer protocol software and the MAC/PHY transceiver. The timing of data transfers, interrupts, and indications between the upper-layer protocol functions and the lower-layer MAC/PHY transceiver functions, therefore, is variable and not known and subject to indeterminate delay and latency, so that the host software and drivers are unable to closely control or accurately determine the timing of the information transmission.

In the IEEE 802.11 environment, for example, the higher layer protocols handle the establishment of and bandwidth reservations for information streams with particular QoS requirements, and assumes the existence of a scheduling mechanism within the logical link or network layer, which is conceptually just above the MAC. For wireless LANs, the scheduling function is always required to achieve QoS at APs and may be required at other stations. For an IEEE 802.11 AP, this scheduler prioritizes outgoing traffic, polls other wireless stations with active QoS streams, and initiates controlled contention intervals. The scheduler delivers an appropriately ordered set of MPDUs (MAC Protocol Data Units) to the MAC transmit function for transmission during each Superframe or interval of time in conformance with the bandwidth priority, latency and other QoS criteria. A Superframe generally begins with transmission of a beacon frame followed by a contention-free period (CFP), which is then followed by a contention period (CP). The AP MAC controller performs the real time point coordination functions, transmits MPDUs, contention control (CC) frames and contention-free (CF) polls as enqueued by the scheduler, receives and validates MPDUs and reservation request (RR) frames, provides valid MPDUs to the MAC repeater of the distribution system as appropriate, controls Superframe timing using initialization parameter values provided by the scheduler or management information base (MIB), and generates acknowledgements, beacons and management frame responses in accordance with the 802.11 standard.

There are several different time bases that exist within the 802.11 AP point coordinator configuration. A first time base includes foreground tasks executed by the MAC in direct synchronism with the time base specified for intervals within 802.11 frame exchange sequences. A second time base includes background tasks activated by the MAC in response to real time events, including signals from foreground firmware, expiration of interval timers, and attention conditions when the host Input/Output (I/O) driver writes to a command register or certain other interface registers. Although background task firmware has direct access to the current 802.11 time synchronization function (TSF) timer value (a 1 microsecond (μs) time base accurate to within 4 μs at all stations in the wireless service set), processing by those tasks is subject to preemption by foreground tasks. Thus, background task processing latency varies due to WLAN traffic, host driver activity and proximity to period boundaries within the Superframe. A third time base is the host system itself, which includes an independent processor that executes the scheduler and distribution functions. The scheduler software has no control over nor ability to measure host processor interrupt response latency. This is especially problematic when the host is running a general purpose operating system, such as Windows NT or the like, rather than a real-time operating system (RTOS), because a general purpose OS is not concerned with limiting interrupt latency whereas an RTOS typically specifies an upper bound on such latency.

The scheduler is responsible for managing MPDU delivery, polling, and contention interval sequence in each Superframe, while the MAC processes outgoing frames in the order they appear on the transmit queue(s) pursuant to transmit commands from the scheduler (across the I/O interface). The MAC generates the beacon to begin the Superframe, then performs transmissions and receptions due to CF-polls and/or CC frames until the transmit queue(s) are empty or until the maximum duration for the CF interval, or CFMaxDuration, is reached. Any undelivered frames remaining on the transmit queue when the CF-End is generated at CFMaxDuration are either returned to the scheduler or discarded, depending upon the status reporting requested by the scheduler when it enqueued those frames. The scheduler generally marks frames belonging to streams with sufficiently large latency tolerance to be returned so that they may be rescheduled for transmission during a subsequent Superframe. By returning such frames to the scheduler, this rescheduling can consider the priority, latency tolerance, incurred waiting time and/or other QoS parameters defined for the stream, as well as ensuring appropriate prioritization and ordering relative to new MSDUs arriving from the distribution system, the wireless medium, or local application layer entities.

There may be a relatively short time period between the end of the CFP and the end of the Superframe. There is no guarantee that the scheduler will be able to respond fast enough to classify new arrivals, retrieve undelivered frames, make the required prioritization decisions, and load the first frame(s) for transmission during the CFP of the next Superframe between the end of a full-length CFP and the end of the Beacon that starts the next Superframe. Furthermore, after the scheduler issues the Transmit command for the first Frame Descriptor (FD) to be used during the new Superframe, several background MAC tasks have to perform some processing before that FD is ready for use by the foreground transmit task. It is noted that there is much foreground activity to preempt these background tasks, in addition to what might occur due to non-QoS traffic during the contention period near the target beacon transmission time (TBTT) when the Beacon is being prepared and transmitted.

Therefore, the scheduler needs to be able to begin submitting frames for transmission during the next Superframe prior to the end of the current Superframe and perhaps before the end of the CFP of the current Superframe. It is necessary to ensure proper allocation of frames to the intended Superframes, regardless of when the first frame for transmission during the next Superframe reaches the head of the relevant transmit queue. For example, it is necessary to achieve equivalent operation if the first frame for transmission during the next Superframe reaches the head of the relevant transmit queue before the end of the CFP of the current Superframe or after the transmission of the CF-End{+ACK} of the current Superframe but before the end of transmission of the Beacon at the beginning of the next Superframe. It is necessary to achieve proper operation when this frame does not reach the head of the transmit queue until after the end of transmission of the Beacon at the beginning of the next Superframe. Because each frame descriptor must be processed by background firmware between the time that the scheduler issues the Transmit command and that descriptor is available to the foreground MAC transmit task, the first frame of the next Superframe may reach the head of the relevant transmit queue after the end of the current Superframe even if the Transmit command for the first frame is issued before the end of the current CFP. Also, due to uncontrollable and unmeasurable (by the scheduler in real time) variations in host interrupt latency, it is not possible to ensure that the first frame of the next Superframe reaches the head of the relevant transmit queue in time even if the frame is submitted in response to a Superframe-timed interrupt, such as in response to a CF-End or a TBTT event.

Other than the sequencing problems described above, which can effect the synchronization between scheduler and MAC transmitter timing, the variable interface delay or latency hinders the scheduler's ability to perform properly various periodic functions and to monitor such periodic functions. Collocated with the scheduler is the point coordinator and the distribution services which provide AP functions. The point coordinator coordinates the flow of frames for active streams of the associated stations, which requires polling those stations for inbound frames. In particular, the point coordinator generates and enqueues polling lists and must monitor the success of the polling lists and make the necessary adjustments. In a QoS environment the scheduler is generally responsible for admittance and re-admittance of QoS frames to the set of transmit queues of the MAC at the AP and for maintaining polling lists for QoS streams. To compensate for the much greater probability of the loss of data frames on a wireless medium, the WLAN MAC protocol incurs significant overhead, including transmission of acknowledgement frames and data frame retransmissions when not acknowledged. This reduces the portion of the already limited wireless bandwidth that is available for user data transfers.

It is desired to implement wireless communications for all types of protocols and architectures that is capable of meeting arbitrary bandwidth and QoS demands by consumers. It is desired to implement wireless communication devices that efficiently utilize the wireless medium to establish and maintain successful wireless communications for many applications, including high bandwidth and latency sensitive voice, video, and multi-media applications. It is desirable to provide service and priority differentiation so that the QoS scheduler function may enforce a bandwidth allocation policy specified by the network operator. Such differentiation, for example, would enable allocation of bandwidth to subscribers who pay for a “premium service” in preference to those who subscribe to a “basic service”.

### SUMMARY OF THE INVENTION

Embodiments of the present invention provide a method and apparatus of synchronizing data transmission on a packet network with time-based framing (ranging from periodic time-bounded to isochronous TDMA) and a traffic scheduler and/or bridge function across an interface with variable and possible non-determinable time delays. A scheduling entity generates ordered sequences of data frames and control frames (such as polls to associated stations) for transmission and marking frames that should be sent at transitions between successive transmission intervals. The scheduling entity transfers both the marked and unmarked frames in order across the variable delay interface to the transmitter function. The host interface function on the opposite side of the variable delay interface places the transferred frames onto the specified one(s) of a set of one or more transmission queues. The transmitter function removes frames from the heads of non-empty queues according to predefined priorities or other policy-based rules and detects marked frames as compared to unmarked frames. While bypassing is not active, the transmitter transmits unmarked frames during each interval until there is insufficient time remaining in that interval to transmit the next queued frame, or until a marked frame is detected. While bypassing is active, the transmitter removes unmarked frames from the queue(s), without attempting transmission, until a marked frame is detected.

Upon encountering a marked frame at the head of the active queue, the transmitter clears the mark of that marked frame and leaves it at the head of the queue so that the frame becomes an unmarked frame. The method may further include the transmitter activating bypassing if a marked frame has not been detected during an interval and deactivating bypassing if a marked frame is detected while bypassing is active. The method may further include the transmitter enabling queue mark detection if a marked frame is detected while queue mark operation is not enabled, incrementing a bypass counter each time a particular periodic interval ends without having detected a marked frame, and disabling queue mark detection if the bypass count reaches a predefined limit value. The method may further include the transmitter signaling the end of an interval upon detecting a marked frame during the interval while queue mark detection is enabled, or upon expiration of the allocated time for the interval, or if there is insufficient time in the interval to transmit another frame or if the queue becomes empty during the interval.

The use of marked frames enables the scheduler to schedule one or more frames for transmission during selected intervals. In one embodiment, the scheduler marks the frame intended as the first frame to be transmitted during a selected interval. Queue mark processing may be enabled or disabled by command of the scheduler and is further enabled automatically upon detection of a marked frame and disabled automatically upon a predefined, positive number of successive intervals without detecting a marked frame. The bypassing mode is used by the transmitter to dequeue and discard or return frames from the transmit queue without attempting transmission if they are present at the head of the queue after the end of the interval appropriate for their transmission. Such bypassing of frames may occur, for example, if the transmitter is unable to transmit all of the queued frames intended for a selected interval or if the host system or variable delay interface is too slow in providing the frames, causing them to arrive after the end of the interval.

The method may further include the transmitter clearing the mark of a marked frame upon detecting the marked frame at the head of the queue while queue mark detection is enabled and transmitting the frame if there is sufficient time remaining in the current interval. If there is not enough time to transmit the frame in the current interval, the transmitter increments the bypass counter to activate the bypassing mode. The method may further include the transmitter setting the bypass counter to zero to disable bypassing if queue mark detection is deactivated because the bypass counter had reached the bypass limit. The scheduler may indicate whether it desires reporting of transmission status for every frame. If so, the transmitter reports to the scheduler whether the frame was transmitted successfully or bypassed. The scheduler may also request that bypassed frames be returned for rescheduling.

A computer system configured for wireless communications across a wireless medium according to an embodiment of the present invention includes a scheduler that generates and forwards frames for transmission and a transmitter that processes the frames. The computer system is coupled to or otherwise includes a variable delay interface with variable delay or latency for communicating with the transmitter. The scheduler marks each frame that is intended for transmission as a first frame of a selected interval of successive transmission intervals. The transmitter operates as previously described to process the frames in the order received from the scheduler. In one embodiment, the scheduler includes a memory system and a processor coupled to a bus system. The memory system stores the software which is executed by the processor. The transmitter includes a host interface, at least one FIFO transmit queue, a transmit frame manager that enqueues frames received via the variable delay interface into a selected FIFO transmission queue, an antenna, a radio transmitter coupled to the antenna for sending and receiving frames, and a MAC protocol controller that processes enqueued frames.

### BRIEF DESCRIPTION OF THE DRAWINGS

A better understanding of the present invention can be obtained when the following detailed description of the preferred embodiment is considered in conjunction with the following drawings, in which:

FIG. 1 is a simplified block diagram of an access point (AP) within a wireless communication system implemented in accordance with an embodiment of the present invention.

FIG. 2 is a block diagram of a computer system configured as an exemplary embodiment of the AP of FIG. 1.

FIG. 3 is a more detailed block diagram of the WLAN card interfaced to the host system of FIG. 2.

FIG. 4 is a simplified diagram of an exemplary frame and frame descriptor.

FIGS. 5A-5C are simplified block diagrams of the transmission logic of the MAC device of FIG. 2 illustrating persistent frame operation.

FIG. 6 is a simplified block diagram illustrating operation between the host driver and the MAC device of FIG. 2 for clearing a persistent frame.

FIGS. 7A-7C show an individual transmit queue of FIG. 2 operating in a manner that illustrates the benefits of persistent frame capabilities for submitting polling lists employing polling frames marked as persistent.

FIGS. 8A and 8B are simplified block diagrams of the transmission logic of the MAC device of FIG. 2 illustrating exemplary queue mark (QM) operation employing the QM field of frame descriptors and optional QM bits.

FIGS. 9A and 9B are simplified block diagrams of the transmission logic of the MAC device of FIG. 2 illustrating an alternative embodiment of the QM operation.

FIG. 10 is a partial block and timing diagram of the transmission logic of the MAC device of FIG. 2 illustrating control capability employing QM operation while there is sufficient time in a given interval I1.

FIG. 11 is a partial block and timing diagram of the transmission logic of the MAC device of FIG. 2 illustrating QM operation when the MAC device does not have time to transmit all frames intended to be sent during the interval I1.

FIGS. 12A and 12B are partial block and timing diagrams of the transmission logic of the MAC device of FIG. 2 illustrating QM operation when the host driver of FIG. 2 is too slow and does not submit frames into the transmit queue of FIG. 3 in time for transmission during the current interval Ii.

FIG. 13 is a tabular diagram illustrating the retry strategy programmed within the RS field of a frame descriptor of a frame.

FIG. 14 is a simplified block diagram of a transceiver that is configured to detect a selectable acknowledgement request in successfully received frames.

FIG. 15 is a flowchart diagram of an exemplary routine of the transmission scheduler of the MAC device of FIG. 2 for processing frames within any of the transmit queues of FIG. 3.

FIG. 16 is a SDL process diagram that describes the behavior of QM processing within the MAC transmission logic.

### DETAILED DESCRIPTION OF EMBODIMENT(S) OF THE INVENTION

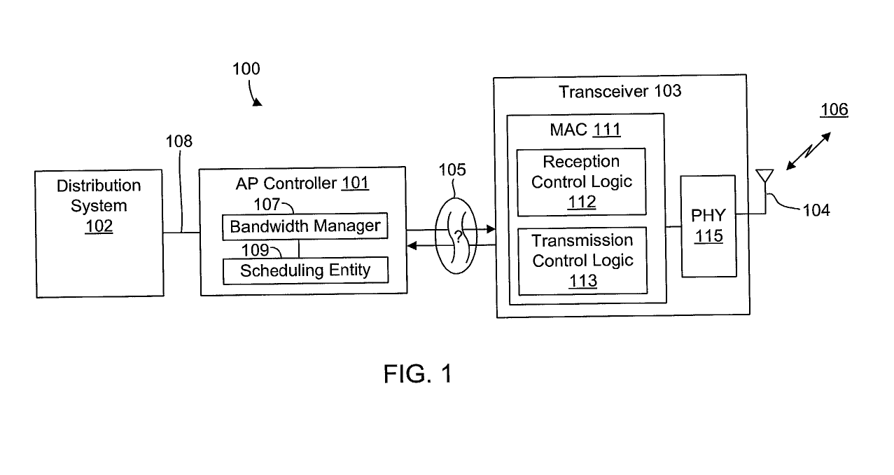

FIG. 1 is a simplified block diagram of an access point (AP) 100 within a wireless communication system. The AP 100 includes a station host or AP controller 101 and a wireless network transceiver 103 that communicate in a wireless medium 106 via at least one antenna 104. It is noted that the AP 100 is also representative of the applicable functionality of a wireless station in accordance with embodiments of the present invention. In the case of a station, the AP controller 101 is typically a personal computer (PC), wireless information appliance, or the like, with various subsystem functions performed by software executing on a processor that is also used to perform other functions of the station. In the case of an AP, the AP controller 101 is typically a dedicated processor that only performs the network-related functions, although there are embodiments of an access point in software that runs on a PC. The more extensive set of functions for illustrating the present invention are utilized at an AP, so hereafter the references are to an AP, with the understanding that the equivalent functions, or a subset thereof, may also exist at a station. In the AP embodiment, the AP 100 communicates with a distribution system 102 via an interface 108.

The AP controller 101 and the transceiver 103 communicate across an internal interface 105, which introduces indeterminate and generally uncontrollable delay of information being transferred, and is thus referred to as a “variable delay” interface. In particular, the AP controller 101 submits fixed- or variable-sized data units, cells, packets or frames, generally referred to as “frames”, via the variable delay interface 105 to the transceiver 103 for transmission. The AP controller 101 may also send command frames or the like to the transceiver 103. In accordance with embodiments of the invention, as further described below, the AP controller 101 further submits frame descriptors that define various transmission policies to be performed by transmitter functions of the transceiver 103. The transceiver 103 receives the frames and frame descriptors from the variable delay interface 105 and transmits the frames onto the wireless medium 106 in accordance with programmed parameters within the frame descriptors. The transceiver 103 also receives frames of information from the wireless medium 106 via the antenna 104 and provides the received frames to the AP controller 101 across the variable delay interface 105. The transceiver 103 may also report status information to the AP controller 101 across the variable delay interface 105. The status information may include for example an indication of whether frames have been transmitted successfully or not.

The particular configuration and implementation of the AP controller 101 depends upon the type of communication network, its data transfer bandwidth and the type and amount of information being processed. In the AP embodiment, the AP controller 101 is a management and frame forwarding entity and coordinates functions across the wireless medium 106 with other network-attached devices known as stations. For example, the AP controller 101 may include both station functionality and provide access to distribution services on behalf of stations communicating via the wireless medium 106. A common instance is the AP 100 and associated stations according to the IEEE 802.11 standard for wireless LANs. In an exemplary 802.11 configuration, the AP controller 101 may further perform point coordination functions (PCF), which are a class of possible coordination functions in which the coordination function logic is active in only one station (required to be the AP in 802.11) in the basic service set (BSS) at any given time that the network is in operation. References to the 802.11 standard and associated operation is exemplary only, where it is understood that the present invention is not limited to 802.11 and may apply to any appropriate wireless communication protocol.

In the embodiment shown, the AP controller 101 includes a bandwidth manager 107 and a scheduling entity 109. The transceiver 103 includes a medium access control (MAC) function 111, which further includes transmission control logic 113 for sending frames and reception control logic 112 for receiving frames. The term “logic” collectively refers to any combination of circuitry and programs, such as software and firmware and the like configured to perform a related set of one or more functions. The reception control logic 112 and the transmission control logic 113 are coupled to a physical-layer (PHY) device 115 of the transceiver 103 for performing wireless communications via the antenna 104. The AP controller 101 ultimately manages the communications conducted by the transceiver 103 across the variable delay interface 105. In many system configurations, the transfer timing across the variable delay interface 105 is not tightly controlled, resulting in substantial and unknown transfer delay that significantly mitigate the ability of the scheduling entity 109 to perform accurate and efficient management of wireless communications by the transceiver 103. The variable timing may be due to interference of hardware or system software or both.

In many network configurations, the distribution system 102 and higher layer communication protocols are not aware that a link of the communications is conducted wirelessly. In an 802.11 configuration, for example, the distribution system 102 and its higher layer protocols are success-oriented as is typical with wired networks, whereas the wireless medium 106 exhibits substantially increased latency and frame loss rate as compared to wireless media. The dynamic and unknown latency across the variable delay interface 105 prevents the AP controller 101 from tightly controlling operations of the transceiver 103. This in turn prevents the AP controller 101 from effectively managing time-critical aspects of the communication conducted via the transceiver 103 across a wireless medium. Without a mechanism to compensate for the effect of the variable delay interface 105, the efficiency and perhaps the interoperability of the wireless network can be impaired.

Embodiments of the present invention are directed towards aspects of the transmission control logic 113 that are directly controlled by the scheduling entity 109 to coordinate and improve communication between the scheduling entity 109 and the transmission control logic 113 across the variable delay interface 105. In one common application, the bandwidth manager 107 and the scheduling entity 109 cooperate to establish and manage quality of service (QoS) admission control, congestion control, prioritization and the like to establish and enforce bandwidth reservations for various information streams and services utilizing the network. The AP controller 101 operates on a substantially different time base as compared to the transceiver 103. Furthermore, higher layer protocols used to manage the distribution system 102 operate in an arbitrary, distributed time base, such as on the order of several milliseconds (ms) or the like. The distribution system 102 is generally asynchronous in nature and operates on global and human-based timeframes and generally manages overall bandwidth allocations and QoS contracts to ensure that information, such as audio and/or video streams of information, are delivered within particular predetermined time constraints, independent of network load of “best effort” data traffic. In general, the distribution system 102 is network agnostic and attaches to a network independent end system that communicates with other end systems that communicate with each other regardless of the particular network configuration through which they are coupled. The distribution system 102 also incorporates intermediate network systems that are stream and service specific.

In contrast, the wireless transceiver 103 operates with much more specific timing constraints on the order of several microseconds (μs) or less. The transceiver 103 must be relatively accurate and must maintain synchronism with wireless network timing within tight timing constraints in order to establish and maintain communication with other wireless devices. For the 802.11 standard, station transceiver synchronism must be maintained to +/−2 μs. Failure to maintain communication protocols and timing constraints at the MAC level results in failure of communication. The wireless medium 106, however, is dynamic and unpredictable. The transceiver 103 must use a wireless communication protocol that includes substantial overhead to overcome characteristics of the wireless medium 106. Furthermore, the transceiver 103 must perform substantial processing in order to measure and quantify the status of the wireless medium 106, such as measuring multipath and other distortion, to determine the distortion in order to accurately decode or demodulate transmitted frames. For example, each frame typically has a known preamble so that the receiver may measure the distortion effects on the preamble and apply the measured distortion to the remainder of the transmitted frame.

In accordance with embodiments of the present invention, many of the communication functions traditionally conducted solely or partially by the scheduling entity 109 are effectively transferred to the transmission control logic 113. In this manner, the AP controller 101 is able to maintain more accurate control and to perform more efficient management of scheduling, coordination and QoS functions that would otherwise not be possible due to the variable delay interface 105. The transmission control logic 113 includes one or more dynamic functions that are under direct control by the scheduling entity 109. In illustrated embodiments, for example, the scheduling entity 109 submits a frame descriptor (FD) with each frame, where the frame descriptor includes one or more programmable fields that instruct the transmission control logic 113 how to handle the corresponding frame. The frame descriptor may be prepended to the frame and transferred to the transmission control logic 113 via the variable delay interface 105. The frame descriptors are not transmitted with the frames, but instead are employed to instruct the transmission control logic 113 regarding transmission of the frames and the reporting of status about the frames.

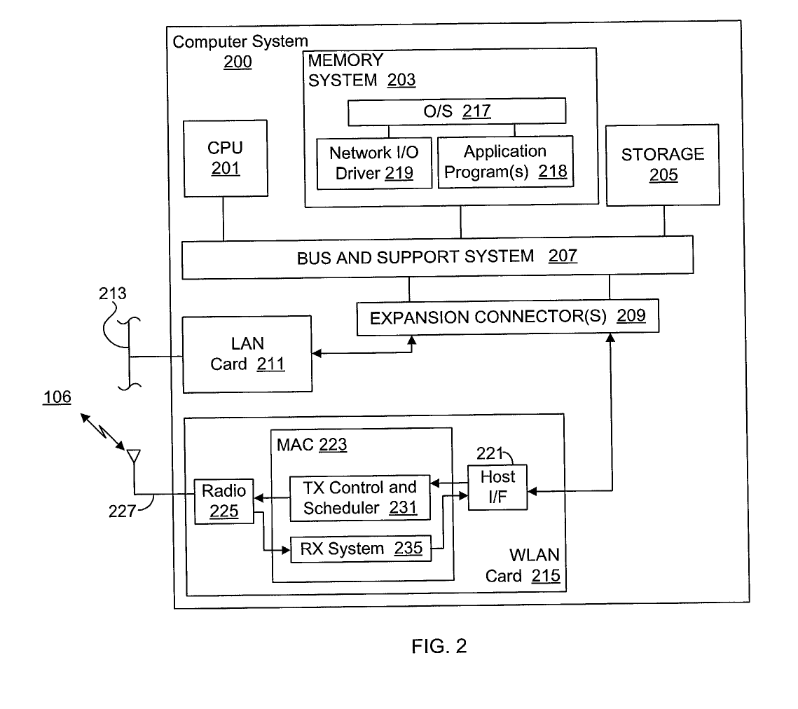

FIG. 2 is a block diagram of a computer system 200 configured to provide AP functionality for purposes of illustrating exemplary embodiments of the present invention, and is a PC specific embodiment of the AP 100. The computer system 200 may be any type of computer system, such as a desktop computer, a portable computer, a laptop computer, or any type of smaller or portable type of computing device, such as a personal digital assistant (PDA) or the like, or any type of embedded computer or processor as known to those skilled in the art. The computer system 200 includes a central processing unit (CPU) 201, which is a general purpose digital processor, zero or more storage devices 205, and a memory system 203 coupled to bus and support system 207. The memory system 203 may include any combination of memory devices, such as dynamic random access memory (DRAM), static RAM (SRAM) devices, programmable and non-programmable read only memory (ROM) devices, etc. The storage 205 may include any type of read or read/write (R/W) data storage devices such as floppy drives, disk drives, tape drives, etc. The bus and support system 207 includes any combination of one or more bus and interface circuits and system support logic appropriate for the particular type of computer system 200. For desktop systems, the bus and support system 207 may include one or more peripheral component interconnect (PCI) buses, one or more industry standard architecture (ISA) buses, universal serial buses (USBs), etc., with one or more corresponding expansion connectors or slots 209 as known to those skilled in the art. For portable computer systems and smaller for factors, the expansion connectors 209 are often implemented as PCMCIA, PC Card slots, compact Flash slots or the like.

To perform the AP function, the computer system 200 includes a local area network (LAN) card 211 for attaching the computer system 200 to a wired LAN 213 which serves as the distribution system 102. For any type of computer system 200 (station or AP), a wireless LAN (WLAN) card 215 is attached into an appropriate expansion connector 209 for interfacing to the computer system 200 to include wireless communication capabilities. The WLAN card 215 includes a host interface (IF) 221 that couples to the bus and support system 207 via the expansion connector 209. The host interface 221 is coupled to a MAC device 223 for performing the MAC function 111, which is further coupled to a radio 225 for performing the PHY device 115 functions. The radio 225 includes at least one antenna 227 for communications on the wireless medium 106, similar to the antenna 104.

The MAC device 223 includes a transmit (TX) control and scheduler system 231 including one or more transmit queues for receiving outgoing FDs and frames from the host interface 221 and enabling transmission of the frames via the radio 225 and the antenna 227. The TX control and scheduler system 231 performs the functions of the TX control logic 113. Frames received from other wireless devices via the wireless medium 106 by the radio 225 via the antenna 227 are handled by a receive (RX) system 235 for validation, address recognition, and, if addressed to this station or AP, for delivery to the computer system 200 via the host interface 221. A portion of the memory system 203 is typically loaded with an operating system (O/S) 217, which further mediates communication between application programs or software 218 and a network I/O driver 219 for communicating with the WLAN card 215. The operating system 217 may comprise, for example, various Windows configurations by MicroSoft, such as Windows 95, 98, ME, 2000, NT, etc. Other suitable operating systems are contemplated, such as Novell Netware or the like. The operating system 217 further loads and manages one or more application software or programs 218 for conducting wireless communications utilizing the WLAN card 215 via the network I/O driver 219 and including AP software to perform the functions of the bandwidth manager 107 and the scheduling entity 109.

The application programs 218, the operating system 217, and the network I/O driver 219, together form an exemplary embodiment of the AP controller 101 previously described, including appropriate AP software. It is understood, therefore, that references to the scheduling entity 109 and the bandwidth manager 107 in association with the computer system 200 are indicative of the CPU 201 executing the operating system 217, the application programs 218 and the network I/O driver 219 from the memory system 203 performing the relevant functions. The operating system 217, the network I/O driver 219, the bus and support system 207 and the host interface 221 generally form an exemplary embodiment of the variable delay interface 105. Thus, application programs 218 must communicate through the variable delay interface 105 in order to manage wireless communications conducted by the WLAN card 215 and controlled by the MAC device 223. Yet the operating system 217 is often not a real-time operating system (RTOS) and is therefore unable to provide for tight and predictable timing of communications between the application programs 218 and the expansion connectors 209, particularly in Windows-based systems. Even if the operation system 217 is an RTOS, the granularity is typically not sufficient for that needed by the wireless MAC protocol. Furthermore, the delays through the bus and support system 207, expansion connectors 209 and host interface 221 are often variable. As a result, the TX control and scheduler 231 is implemented with additional programmable capabilities to enable and improve communications between the application programs 218 and the MAC device 223.

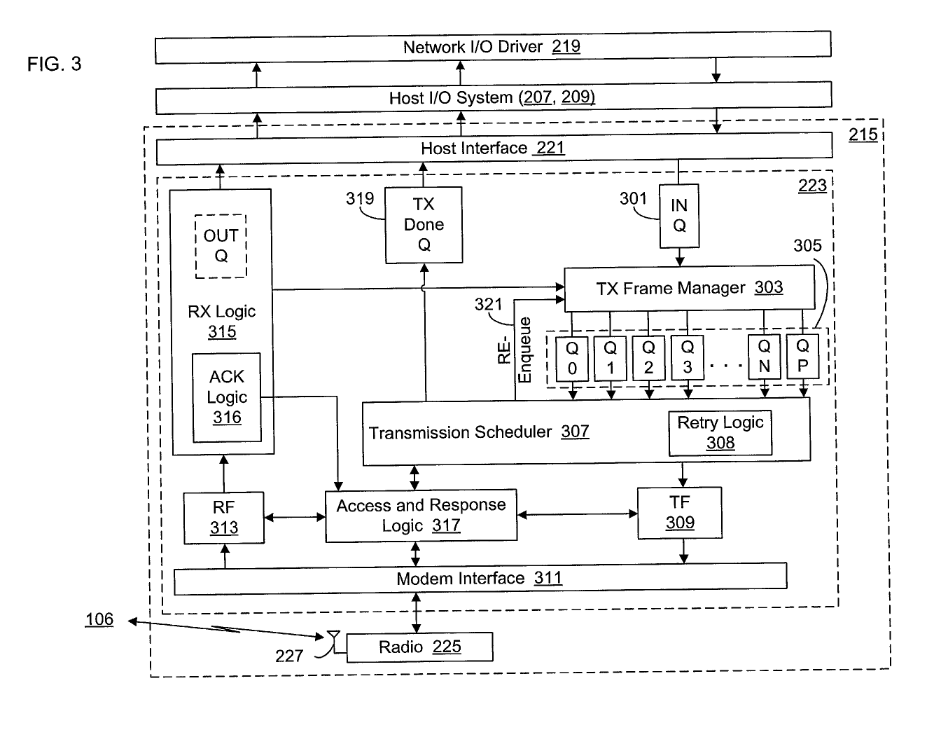

FIG. 3 is a more detailed block diagram of the WLAN card 215 as interfaced to the network I/O driver 219 via the host I/O system 207, 209. The MAC device 223 interfaces the host interface 221, which transfers frames and frame descriptors (FDs) for transmission from the host driver 219 to an input queue (IN Q) 301. A transmit (TX) frame manager 303 retrieves frames and FDs from the IN Q 301 and enqueues each frame and FD into one of several transmit queues 305, individually labeled Q0, Q1, Q2, Q3 . . . QN, where “N” is any positive integer, although a single transmit queue 305 is 20 contemplated as well. Any one or more of the transmit queues 305 may be configured or operated as first-in first-out (FIFO) queues, although other types of queues are contemplated. Regardless of whether a transmit queue is configured or operated as a FIFO queue, any one or more of the queues may allow non-FIFO removal behavior based on other properties of queued elements, such as priority, destination address, frame type, etc. Also, a persistent queue, labeled QP, is contemplated in which all frames enqueued therein are considered persistent frames. In one embodiment, a separate persistent queue QP is provided so that each frame enqueued thereon, as instructed by the controller or scheduler, is considered a persistent frame until deleted from the queue QP. Alternatively, any of the transmit queues 305 may be temporarily or permanently programmed as a persistent queue QP.

In the embodiment shown, the transmit queues 305 are organized according to level of priority. In particular, the first queue Q0 is used to hold the lowest priority pending transmissions intended for best effort frames. A next priority queue Q2 is intended for medium priority frames. Higher numbered queues, such as Q3-QN are intended for high-priority traffic. In a particular 802.11 embodiment for example, the low priority queue Q0 is intended for best effort MPDU and for MMPDUs and the like to be transmitted during the contention period (CP). Q2 is for transmission of frames of high priority during the contention free period (CFP) and intended for contention-free asynchronous delivery and for CF-poll frames of stations or the contention free (CF) polling list. The high-priority queues beginning with Q3 are for frames to be transmitted first during CFP and intended for latency-sensitive or jitter-sensitive traffic. The TX frame manager 303 detects the type and priority of each frame pulled from the IN Q 301 based on information in the FD, and inserts the frame at the end of an appropriate one of the transmit queues 305.

Each transmit queue 305 has sufficient capacity for storing multiple frames or MPDUs in first-in, first-out order for transmission. Each transmit queue 305 may further include a provision for storing a frame descriptor for each frame, where the frame descriptor, further described below, includes various parameters as to how or when the corresponding frame is to be transmitted. Additionally, each transmit queue 305 may provide storage of a programmable marker for each frame, referred to as a queue mark (QM) bit or the like, that is used for QM operation as described further below. QM operation allows a correspondence to be established between a point in the frame sequence from the scheduling entity 109 running on its time base and on its side of the variable delay interface 105 with a point in the MAC protocol sequence, such as the start of a particular interval, in the time base of the MAC controller and on the opposite side of the variable delay interface 105. This function of QM is reflected in its context-dependent usage, which is sometimes delay, sometimes discard, sometimes start, sometimes stop, etc. Additionally, each transmit queue 305 may provide storage of a programmable persistence flag or marker for each frame, such as a persistence bit or the like, that is used to implement frame persistance as described further below.

The outputs of the transmit queues 305 are provided to a transmit scheduler 307, which schedules frames from the transmit queues 305 for transmission via a transmit function (TF) 309. The transmit function 309 provides frames for transmission via the modem interface 311, which conveys the frames to the radio 225 for transmission via the antenna 227. Frames received by the radio 225 are provided to a receive function (RF) 313 via the modem interface 311, and are then provided to receive logic 315. The receive logic 315 provides the received frames to the network I/O driver 219 through the host interface 221. Additional detail of the receive (RX) logic 315 will not be further described herein other than reference to acknowledge (ACK) logic 316 described further below. Access and response logic 317 is coupled to the modem interface 311, the transmit function 309, the receive function 313 and the transmission scheduler 307 for controlling wireless communications and facilitating coordination between transmitting and receiving frames. The transmission scheduler 307 conveys frames via a transmit (TX) done queue 319 to the host interface 221 for purposes of completion status reporting to the host, in such a manner that decouples the rate at which the host queries such status from the rate at which the MAC device 223 processes FDs. For example, frames that are retrieved from the transmit queues 305 and that bypass the transmit function 309 (e.g., not transmitted or “dropped”), are placed by the transmission scheduler 307 onto the TX done queue 319 with a status bit set to indicate that the frame was not delivered. As described further below, the transmission scheduler 307 includes a re-enqueue path 321 to the TX frame manager 303 for re-enqueuing persistent frames as further described below. It is noted that transmission and re-enqueuing operations may be considered independent operations and it is not intended that they be performed in any particular order.

As described previously, a common communication mechanism between the network I/O driver 219 and the MAC device 223 is based on interrupts. Host interrupt latency is variable, unknown and for the most part, uncontrollable by the software. Therefore, the timing of communications, frame transfer and indications between the application programs 218 and the MAC device 223 is variable and not known. Improved communications across the variable delay interface 105, such as including the operating system 217, the network I/O driver 219, the bus and support system 207 and the expansion connectors 209, are described herein so that the applications and network I/O driver 219 are able to manage properly information transmission by the MAC device 223. As further described below, each frame descriptor associated with a corresponding frame forwarded by the network I/O driver 219 to the MAC device 223 includes a queue mark (QM) field that serves as a timing index that allows the transmission scheduler 307 to determine whether to transmit (or to drop) one or more frames for purposes of synchronizing the sequence of frames to the transfer intervals defined by the MAC protocol. This timing index allows the transmission scheduler 307 to realign timing to what is intended by the scheduling entity 109 on the host side of the variable delay interface 105.

The frame descriptor further includes a persistence (PRST) field that instructs the transmission scheduler 307 to re-enqueue the corresponding frame after processing by submitting the frame back to the TX frame manager 303 via the re-enqueue path 321. The frame descriptor includes a retry strategy (RS) field that instructs the TX frame manager 303 regarding the retry strategy for the corresponding frame, such as whether to retry the frame in the event that the initial delivery attempt is unsuccessful, and if unsuccessful, how many times to retry the frame. The frame descriptor may further include a frame lifetime (FL) field that includes a timing parameter that specifies a retry time duration. The retry time duration may be used instead of a retry number or in addition thereto. If a retry count is specified along with a frame lifetime, the frame is retried up to the specified number of times defined by the retry count or until expiration of the frame lifetime, whichever occurs first.

The transmission scheduler 307 optionally includes retry logic 308 that modifies a frame based on the programmed value within the RS field of the frame descriptor of the frame. In one embodiment, the retry logic 308 programs the duration/ID field of the MAC header information of the frame to be transmitted with at least one acknowledgement request (AR) bit that indicates to the receiving device whether to transmit an ACK frame to indicate successful reception. The duration/ID field may include the same bits of the RS field to indicate the retry strategy and the acknowledgement request. Alternatively, a separate field may be employed, such as a Quality of Service (QoS) control field or the like, to specify the retry strategy. The retry strategy function is relevant if the MAC protocol includes MAC-layer acknowledgement and retry of unacknowledged frames. These are not traditionally used at the MAC layer, but are often added in MAC protocols intended for use over wireless physical layers, such as 802.11. A retry strategy control for number retry attempts is useful with any MAC protocol that includes ACK and retries. An additional benefit, however, is achievable if it is possible within the protocol to selectively suppress the generation of the ACK response for the transmissions that are not going to be retried even if the transmission is unsuccessful. An example of this are frames of a real-time video stream for which there is typically insufficient time to perform the retry, so the visible effect to the viewer is reduced if the subsequent frames are not delayed by retries of previous frames. These cases allow further improvement of throughput because if the sending station knows that no ACK will be returned, then the next outgoing frame can be transmitted without waiting for the ACK frame, and eliminating the time normally reserved for the ACK frame and its corresponding inter-frame gap. The 802.11 protocol was standardized without provision for a selective ACK function. In one embodiment, a “do not ACK” message is encoded into an existing field of frame to be transmitted where the message is ignored by stations that do not support the option. A good place to do this for 802.11 contention free transmissions are bits within the low order 14 bits of the duration/ID field of the MAC header when the highest order 2 bits are both set to logic “1”. During normal operation, a receiving device transmits an ACK frame a short interframe space (SIPS) period after successfully receiving a frame from a transmitting device. As further described below, the ACK logic 316 in the RX logic 315 examines the received frame and does not transmit an ACK frame if the frame was valid and addressed to this station, but the acknowledgement request bit indicates that an ACK frame is not requested.

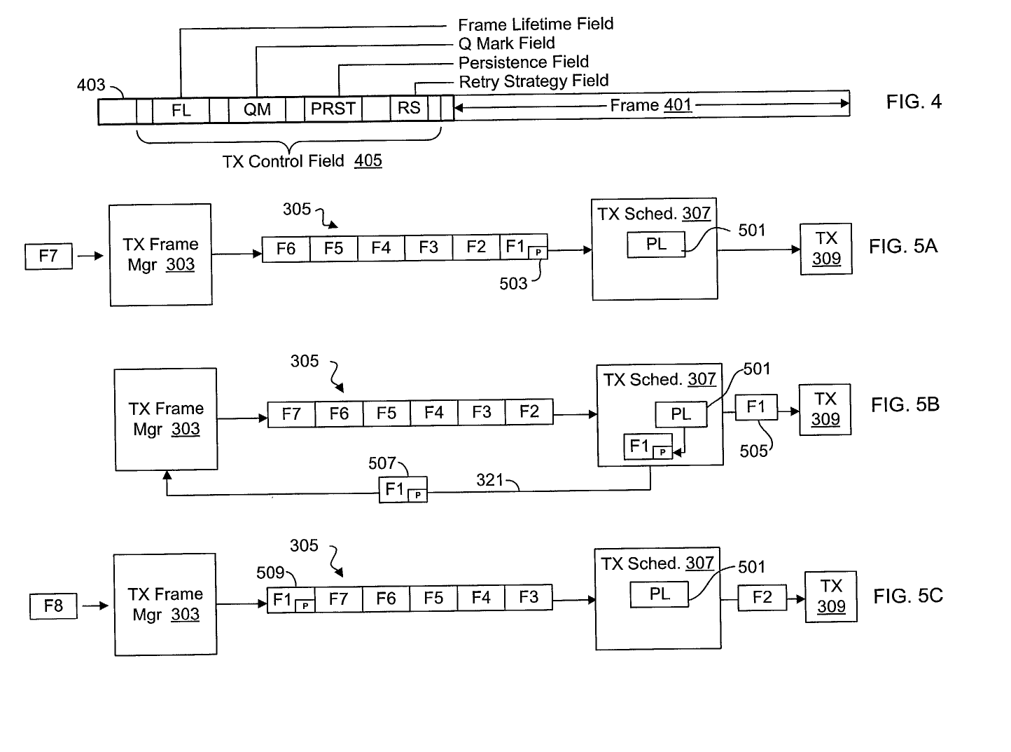

FIG. 4 is a simplified diagram of an exemplary frame 401 and a frame descriptor 403 implemented according to an embodiment of the present invention. In the embodiment shown, the frame descriptor 403 is appended to (or otherwise associated with) the frame 401 by the network I/O driver 219 or other higher layer logic or software and transferred to the MAC device 223 via the variable delay interface 105. The frame descriptor 403 further includes a TX control field 405, which further includes one or more fields programmable by the network I/O driver 219 and/or application programs 218 for purposes of controlling transmission via the MAC device 223.

As shown, the TX control field 405 includes a retry strategy (RS) field for defining one of several selectable retry strategies for the frame 401. The TX control field 405 further includes a frame lifetime (FL) field that includes a retry timing value that specifies a maximum amount of time to retry a frame if it is to be retried. The controller or scheduler may program the FL field to be used alone or in combination with the retry strategy. For example, a retry duration may be used instead or to override any specified retry count so that the associated frame is retried until expiration of the specified frame lifetime. Or, the retransmission of the frame may be attempted until expiration of the frame lifetime or as many times as indicated by the retry count, whichever occurs first. A null value may be programmed into the frame lifetime field if a lifetime is not to be used.

The TX control field 405 includes a persistence (PRST) field for marking the frame 401 as a persistent frame. The TX control field 405 further includes a queue mark (QM) field that marks the frame 401 as a QM frame for purposes of establishing a reference point in the queued sequence of frames that is to be transmitted in synchronism with the MAC timing for a particular interval, or not transmitted if such synchronism cannot be established. The QM field may comprise a single bit to mark the corresponding frame for QM operation. It is noted that when a frame is said to be marked for QM operation, making that frame a QM frame, it is understood that the QM field of the corresponding frame descriptor contains a bit or code value that indicates the QM operation. In one embodiment, the QM field indicates that the frame 401 is to be transmitted as the first frame in the next instance of a particular type of transmission interval. In another embodiment, the QM field denotes the frame as the last transmitted frame in a current interval. A QM frame may or may not be intended for transmission. The present invention contemplates any of these variations for programming the QM field.

FIGS. 5A-5C are simplified block diagrams of a portion of the MAC device 223 illustrating persistent frame operation. As shown in FIG. 5A, a selected one of the transmit queues 305 is loaded by the TX frame manager 303 with six frames supplied by the network I/O driver 219, F1, F2, F3, F4, F5 and F6 in order so that F1 is intended to be transmitted first and F6 last. Another frame F7 is being provided by the network I/O driver 219, such as the next frame in the IN Q 301. In one embodiment, the transmit queue 305 is a FIFO queue, so that the intended transmission order is from right to left where the transmit queue 305 effectively operates as a linear buffer. The transmit scheduler 307 dequeues each frame one at a time for submission to the transmit function 309. The transmit scheduler 307 also dequeues and inspects each corresponding frame descriptor. Thus, when the transmit scheduler 307 is operating from the transmit queue 305 as shown, it dequeues the frames F1, F2, F3, F4, F5 and F6 in that order for delivery to the transmit function 309 for transmission.

The transmit scheduler 307 includes persistence logic (PL) 501 that detects persistent frames to enable persistent frame operation. As shown, persistent frames, such as a first frame F1, are indicated by a persistent indicator “P”, where persistent frames are indicated in any one of several ways. In one embodiment, the frame descriptor of a frame has its PRST field programmed as a persistent frame. In another embodiment, a persistent frame bit or the like programmed into the corresponding transmit queue 305 by the TX frame manager 303 when the frame is enqueued. In another embodiment, the frame is considered persistent when enqueued into a persistent queue, such as the queue QP or any transmit queue 305 that is programmed as persistent. In another embodiment, any frame of a certain frame type may automatically persistent frames, such as polling frames or the like. The persistence logic 501 is configured to detect persistent frames according to any one or more or a combination of all of these methods depending upon the particular configuration desired.

As shown in FIG. 5B, the transmit scheduler 307 dequeues the next frame F1 from the transmit queue 305 and the persistence logic 501 detects that the frame F1 is persistent and asserts a persistent signal indicative thereof. It is noted that the persistence logic 501 may be implemented in any of many ways, such as by firmware or by logic either separate from or incorporated within the transmit scheduler 307. The transmit scheduler 307 detects the persistent signal and identifies the frame as persistent. The transmit scheduler 307 submits the frame F1 to the transmit function 309 for transmission as shown at 505, excluding the frame descriptor. Furthermore, the transmission scheduler 307 copies the persistent frame Fl and its frame descriptor back to the TX frame manager 303 via the re-enqueue path 321 as shown at 507. In this case, the next frame F7 supplied by the network I/O driver 219 was added to the end of the transmit queue 305 by the TX frame manager 303 by the time the re-enqueuing of frame F1 occurred.

As shown in FIG. 5C, the TX frame manager 303 re-enqueues the persistent frame F1 into the transmit frame 305 as shown at 509. The corresponding frame descriptor is also enqueued so that the frame maintains its persistent status. Alternatively, if a persistent bit is included in the transmit queue 305, the TX frame manager 303 programs the corresponding persistent bit to keep the frame marked as persistent. If the frame is re-enqueued into a persistent queue, then it will maintain its persistent status until deleted from the queue. Meanwhile, the transmit scheduler 307 operates as normal, dequeuing the next frame F2 for delivery to the transmit function 309 for transmission. Upon successful completion of regular, non-persistent frames, the transmission scheduler 307 may return a completion status via the TX done queue 319. In one embodiment, such completion status is not returned if the persistent frame was successfully transmitted and successfully re-enqueued. The persistent frame F1 is repeatedly processed by the transmit scheduler 307 and resubmitted to the TX frame manager 303 via the re-enqueue path 321. Operation repeats in this manner for as long as the frame F1 is marked as persistent and the transmitter remains enabled. In one embodiment, a persistent frame is always resubmitted to the same transmit queue 305 from which it was retrieved. In an alternative embodiment, a persistent frame may be resubmitted to any of the transmit queues 305 by the TX frame manager 303.

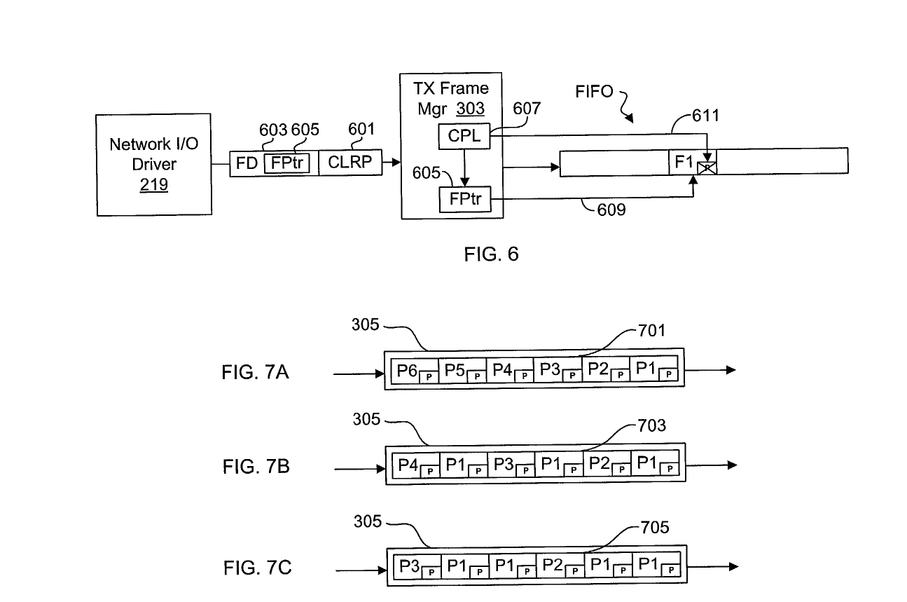

FIG. 6 is a simplified block diagram illustrating operation between the network I/O driver 219 and the MAC device 223 for clearing the persistent bit in a queued frame descriptor or a bit of the queue. In particular, the network I/O driver 219 submits a clear persistent (CLRP) command frame 601 along with a frame descriptor (FD) 603 that includes a frame pointer (FPtr) 605 descriptor number, or the like, that identifies or otherwise points to a particular persistent frame, such as the frame F1. The TX frame manager 303 includes clear persistence logic (CPL) 607, which retrieves the frame pointer 605 from the CLRP command frame 601 to identify the particular persistent frame F1 as shown at 609. Upon identifying the persistent frame F1, the clear persistence logic 607 either modifies the PRST field of the frame descriptor or clears the persistent bit of the frame F1, as shown at 611, so that it is no longer marked as persistent. In this manner, once the frame F1 is no longer marked as persistent, it is processed in the same manner as a normal frame and not re-enqueued. In typical cases the CLRP command frame and descriptor is then discarded or marked as successfully completed and passed back to the network I/O driver 219, but in any case the CLRP command frame is not transmitted.

The use of the PRST field to mark a frame as persistent provides many benefits and advantages for improving the control of wireless communications. In order to properly implement a packet oriented wireless communications protocol, and some types non-packet protocols, the application programs 218 and/or the network I/O driver 219 needs to conduct periodic functions or operations over predetermined or arbitrary periods of time. For example, one or more application programs at other stations on the wireless network may need to transmit successive frames of a voice stream with the transmissions occurring at predefined intervals corresponding to the sampling rate of their vocoders. This periodic service needs to occur with a high degree of uniformity of jitter of as little as a few tens of milliseconds can impair delivered audio quality. The best way to achieve this uniformity of transmission opportunity timing in a WLAN protocol like 802.11 is to use contention free frame delivery, in which the AP periodically polls the stations to facilitate such transmissions. For example, a WLAN may include three other wireless stations, W1, W2 and W3, other than the access point controller that need to communicate. The access point main processor via the network I/O driver 219 periodically polls each of the wireless stations W1-W3 in any particular order and according to any particular priority or predetermined service rate specification. For communications according to 802.11 for example, a CF polling list is maintained by the AP where one or more of the other wireless devices in the WLAN are periodically polled to enable communication with those devices.

In the conventional network interface card (NIC) model, such repetitive activities would require the scheduling entity 109 or the network I/O driver 219 to resubmit frames, such as CF polling frames for each repetition, although these types of activities are not as common for conventional, wired networks as they are for wireless networks. As described previously, however, the variable delay interface 105 imposes significant overhead and indeterminable delays on each such resubmission, which is an obstacle to the periodic functions being conducted in an orderly and repetitive fashion. During low levels of traffic, this requirement may be relatively easy to maintain. However, for periods of heavy traffic, and due to the variable delay interface 105, it is difficult for hostbased software, such as the scheduling entity 109, to properly and timely perform the periodic functions.

The use of persistent frames facilitates the periodic functionality to occur without multiple or repetitive traversals of the variable delay interface 105. The software, such as the scheduling entity 109, need only mark one or more frames as persistent or enqueue the frames into a persistent queue or submit persistent frame types to establish the periodic retransmission of those frames to implement the periodic function. The persistent frames may thus be processed at the maximum rate allowed by the protocol rules and other, non-persistent frames, or may be synchronized with particular protocol-defined intervals by the combined use of the persistent and QM functions. The MAC device 223 automatically re-enqueues persistent frames after processing. The host system submits the clear persistent command to reprogram any persistent frame as a normal frame or to delete a frame from a persistent queue. In this manner, the persistent frame programmability enables the host system to control periodic functions, including polling frames, across the variable delay interface 105.

FIGS. 7A-7C illustrate the benefits of persistent frame capabilities for submitting polling lists employing polling frames marked as persistent. As shown in FIG. 7A, a selected one of the transmit queue 305 is loaded by the network I/O driver 219 with a polling list 701 including six CF-poll (“P”) frames P1-P6 each marked as persistent. In this embodiment, six different wireless stations in the WLAN, such as wireless stations W1, W2, W3, W4, W5 and W6, are each polled with a respective CF-poll frame P1, P2, P3, P4, P5 and P6. After the wireless station W1 is polled with CF-poll frame P1, the CF-poll frame P1 is reenqueued to the corresponding transmit queue 305 by the transmit scheduler 307 and the TX frame manager 303 via the re-enqueue path 321 as previously shown in FIG. 5B. Since each of the CF-poll frames P1-P6 are marked as persistent, the polling list order is maintained since each frame after being transmitted or otherwise processed is returned to the end of the same transmit queue 305. As shown by the polling list 701, the wireless stations W1-W6 each receive an equal number of CF-poll frames per cycle through the polling list.

FIG. 7B illustrates an alternative polling list 703 loaded into a transmit queue 305. In this case, the CF-poll frames are ordered P1 P2, P1 P3, P1, P4 and so on. The frames of the polling list 703 are each marked as persistent in a similar manner as the polling list 701. In this case, however, the station W1 addressed by the CF-poll frame P1 requires additional data transfer bandwidth such as may be necessary for a device conducting video conferencing. Thus, the wireless station W1 requests this amount of bandwidth and, upon granting the request, the scheduling entity 109 generates the polling list in which the station W1 is polled 50% of the time while each of the remaining wireless stations W2, W3 and W4 equally split the remaining 50% of the time.

As shown in FIG. 7C, an alternative polling list 705 is loaded into a transmit queue 305. In this case, wireless stations W1, W2 and W3 are each addressed by a corresponding CF-poll frame P1, P2 and P3. The polling list configuration is P1, P1, P2, P1, P1, P3. In this case, the wireless station W1 is roughly 67% of the available bandwidth, as compared to the wireless stations W2 and W3, which equally share the remaining 33%. It is appreciated that the polling lists 701, 703 and 705 are exemplary only and that any polling configuration allowed under the operative MAC protocol is possible as contemplated by the present invention. Of course, a particular transmit queue 305 may include less or substantially more number of frames as opposed to the six frames shown in FIGS. 7A-7C. It is also noted that any number of queues may be used in this manner. Also, the persistent queue QP may be used or a transmit queue 305 may be programmed as a persistent queue, although in either case any frame enqueued would also have the persistent status. Further, some or all of the polling frames may be considered persistent by virtue of frame type.

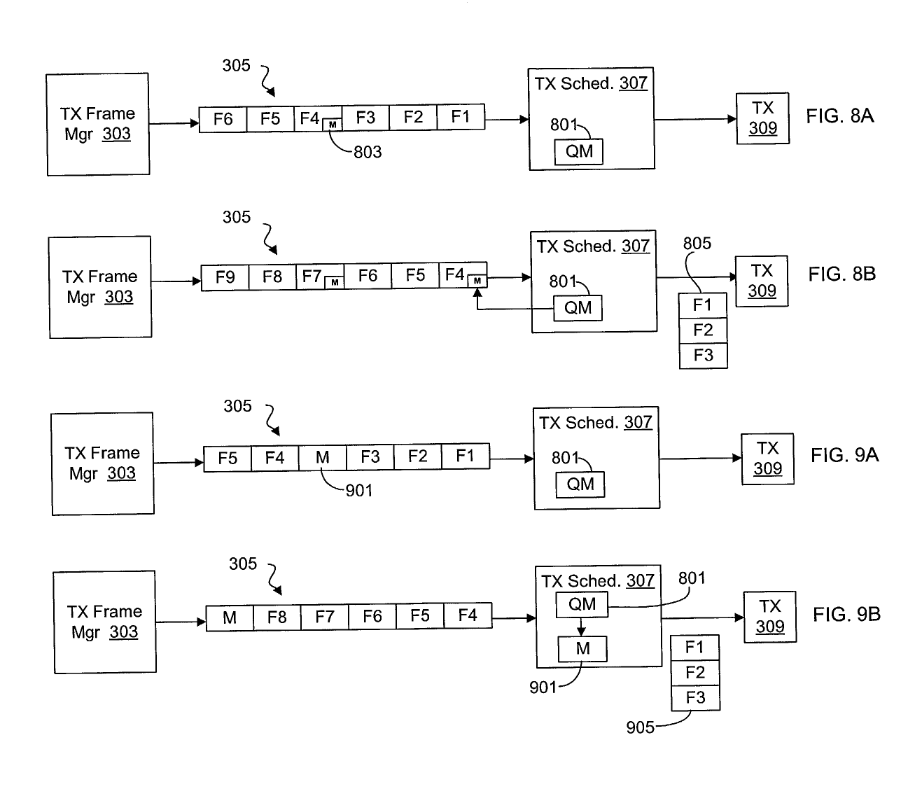

FIGS. 8A and 8B are simplified block diagrams of the MAC device 223 illustrating exemplary queue mark (QM) operation employing the QM field of frame descriptors and QM bits. As shown in FIG. 8A, the TX frame manager 303 has loaded a transmit queue 305 with six frames F1-F6. The frame descriptor of the frame F4 has its QM field marked for QM operation, so that the QM bit of the transmit queue 305 is set as shown as an “M” at 803. The transmission scheduler 307 includes QM logic 801 for detecting QM frames and controlling transmission in accordance with QM operation. As shown at FIG. 8B, the transmission scheduler 307 has dequeued frames F1-F3 from the transmit queue 305 for transmission by the transmit function 309 as shown at 805. The next frame F4 is detected as a marked frame by the QM logic 801 of the transmission scheduler 307. In this embodiment, the frame F4 is therefore not intended to be transmitted in the same interval with the frames F1-F3, but instead, is intended to be transmitted as the first frame of the next such interval. Therefore, the transmission scheduler 307 does not transmit the frame F4 in the current interval even if there is remaining time in that interval. The transmit queue 305 is considered logically empty when a marked frame is detected at the head of that queue and transmission from that queue is suspended for the remainder of the current interval. Although this may appear to be less efficient if there is further time left in the current interval, the transmission scheduler 307 instead may retrieve other frames, such as from higher or lower-priority queues during the remaining time in the interval. In this manner, the transmit function 309 and the wireless medium 106 do not necessarily remain idle. Further, QM operation enables the application programs 218, including the scheduling entity 109, via the network I/O driver 219 to identify which frames are intended to be transmitted during particular intervals of time across the variable delay interface 105 because the intended interval is independent of the interval in progress when the frame reaches the queue. This further enables the scheduling entity 109 to control quality of service and meet timing constraints and to reduce or otherwise mitigate latency and jitter that exceeds the committed service level.

FIGS. 9A and 9B are simplified block diagrams of a subset of the MAC device 223 illustrating an alternative embodiment of the QM operation. In this case, the frame descriptor of a frame having its QM field marked as shown at 901 is not intended for transmission and is simply marked with an “M” indicating a QM frame which occupies a particular place in the queue. As shown in FIG. 9B, after the frames F1-F3 are transmitted in the current interval, the transmission scheduler 307 retrieves the QM frame 901 and suspends further transmission from the particular transmit queue 305. Thus, the remaining frames F4, F5, F6, F7 and F8 are delayed until the start of the next such interval. The transmission scheduler 307 retrieves any frames from other lower or higher-priority queues and stops retrieving frames from the transmit queue 305 in the current interval. In this embodiment, an entire position on the queue is employed to demarcate frames for successive intervals, which may be considered less efficient than simply marking a frame intended for transmission, but in some cases allows faster processing or simpler management of the queue data structure.

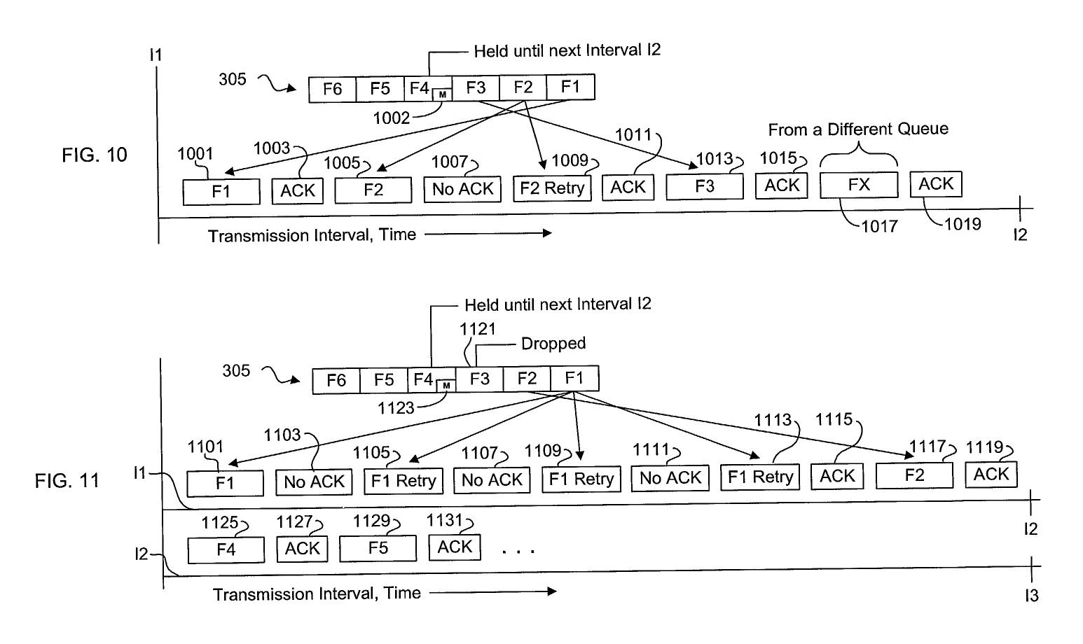

FIG. 10 is a partial block and timing diagram illustrating control capability employing QM operation while there is sufficient time in a given interval I1. The transmit queue 305 is loaded with six frames F1-F6, where F1, F2 and F3 are intended to be transmitted in the current interval I1 and the frames F4-F6 are intended to be transmitted in the next sequential interval I2. In this manner, the frame F4 is marked as a QM frame as shown at 1002. As shown in the timing diagram, the frame F1 is transmitted as shown at 1001 followed by an acknowledge frame (ACK) 1003 transmitted by that station which received the frame F1. Then, frame F2 is transmitted as shown at 1005, which is not followed by an ACK frame from the receiving station during the relevant time as shown as “No ACK” at 1007. Since the frame F2 has not been successfully received, the sending of F2 is retried as shown at 1009. This transmission is successful as indicated by a subsequent ACK frame being received as shown at 1011. Then, the next frame F3 is transmitted as shown at 1013 and successful receipt indicated by an ACK frame 1015.

At this point in time, it is noted that the interval I1 has sufficient time to transmit at least one more frame from the transmit queue 305. In conventional systems, the next frame F4 would be transmitted during the interval I1. Instead, since the frame F4 is marked as a QM frame, it is held until the start of the next interval I2, and the transmit queue 305 is considered logically empty for the rest of the interval I1. A frame from a different transmit queue 305, denoted “FX”, is transmitted next during the remaining time of interval I1 as shown at 1017 followed by a corresponding ACK frame 1019. In this particular case, all of the frames F1-F3 were successfully transmitted during the current interval I1 by the MAC device 223 as intended by the scheduling entity 109.

FIG. 11 is a partial block and timing diagram illustrating QM operation when the MAC device 223 is not able to successfully transmit all the intended frames during the interval I1. Again, the transmit queue 305 is loaded with frames F1-F6 by the host system for transmission, where the frame F4 is marked as a QM frame as shown at 1123. Thus, the scheduling entity 109 intends that frames F1-F3 be transmitted during the first interval I1 whereas the remaining frames F4-F6 are to be transmitted during the next sequential interval I2. As shown at 1101, the MAC device 223 attempts to transmit frame F1. As shown at 1103, the intended receiver does not provide an ACK frame. Thus, F1 is retried as shown at 1105 illustrated as “F1 Retry”. Again, there is no ACK frame as shown at 1107 so that F1 is retried again at 1109. Once again, there is no ACK frame as shown at 1111 so that F1 is retried again at 1113. Finally, an ACK frame is received as shown at 1115, so that the MAC device 223 transmits the next frame F2 as shown at 1117. An ACK frame for the frame F2 is received as shown at 1119, but there is insufficient time during the current interval I1 to transmit the next frame F3. The MAC device 223, therefore, removes the frame F3 from the queue without attempting to transmit that frame as shown at 1121. The frame F3 is either discarded or returned to the host interface with a completion code of “dropped” as desired by the network I/O driver 219.

In conventional operation, a MAC device 223 would not discard the frame F3, but would instead wait to transmit frame F3 in the next interval I2. However, since the network I/O driver 219 has marked frame F4 as the first frame to be transmitted in the next interval I2, the MAC device 223 drops the frame F3. It is noted that several variations are possible. In one case, the host system may require reporting of dropped frames so that the MAC device 223 reports back to the network I/O driver 219 that frame F3 was dropped. Alternatively, the host may specify that no reporting is necessary so that the frame F3 is simply dropped without reporting back to the host system. If reporting is required, then frame F3 “bypasses” the transmit function 309 is directly placed on the TX done queue 319. In one embodiment, a dropped status field (not shown) of the frame descriptor of F3 is set to indicate that the frame F3 was not transmitted. If the dropped status field is not marked, the frame F3 is simply dropped and not forwarded back to the host system. The network I/O driver 219 programs each frame to specify whether host reporting is necessary for that frame.

As shown at 1125, the QM frame F4 is transmitted by the MAC device 223 as the first frame during the next interval I2. This is followed by an ACK frame as shown at 1127, which is followed by transmission of the next frame F5 as shown at 1129 followed by an ACK frame at 1131 and so on. In this manner, it is appreciated that frames F1 and F2 are transmitted during interval I1 and frame F3 is dropped. The frames F4, F5 and so on are transmitted during the subsequent interval I2 in accordance with the instruction conveyed by the QM on the frame F4.

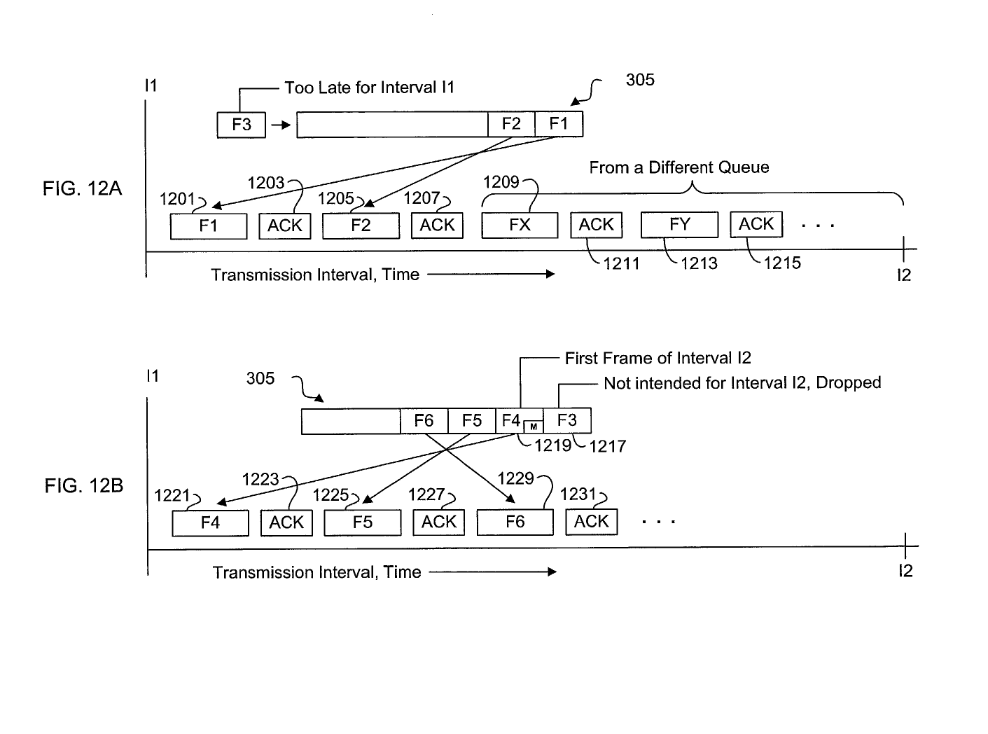

FIGS. 12A and 12B are partial block and timing diagrams illustrating QM operation when the host system (an indeterminate combination of the network I/O driver 219, higher layer application programs 218, and/or the delays through the variable delay interface 105) is too slow and does not submit all of the desired frames into the transmit queue 305 in time for transmission during the current interval I1. The MAC device 223 retrieves and transmits the first frame F1 as shown at 1201, which is followed by an ACK frame at 1203. The MAC device 223 retrieves and transmits the next frame F2 as shown at 1205, which is followed by an ACK frame at 1207. At this point in time, the transmit queue 305 is physically empty since the next frame F3 has not yet been enqueued to the transmit queue 305 by the TX frame manager 303 and may not yet have even been transferred from the network I/O driver 219 in time for transmission. It is assumed in this example that QM operation is enabled and that no marked frame has been detected during interval I1. Since the transmit queue 305 is physically empty, the transmission scheduler 307 may begin retrieving frames from another transmit queue, such as frames “FX” and “FY” shown at 1209 and 1213, respectively, each followed by corresponding ACK frame shown at 1211 and 1215, respectively.

In one embodiment, once the transmission scheduler 307 encounters a physically empty queue without encountering a marked frame while QM operation is enabled, it begins transmitting from a different queue without returning to the transmit queue 305 if frames subsequently become available for transmission while still in interval I1. In an alternative embodiment, the transmission scheduler 307 ultimately transmits the frame F3 during the interval I1 if the frame is enqueued to the transmit queue 305 before the end of the interval I1, even if other frames such as frames FX and FY have previously been transmitted during the interval I1. In other words, the frame F3 is transmitted during interval I1 if it reaches the head of the transmit queue 305 while there is sufficient time during the interval I1 for its transmission. In yet another embodiment, when the transmit queue 305 becomes physically empty, the MAC device 223 ceases to transmit for the remainder of the interval I1. It is assumed in FIG. 12A, however, that the frame F3 has arrived in the transmit queue 305 too late for transmission during the interval I1.

As shown in FIG. 12B, during the subsequent interval I2, the network I/O driver 219 has loaded the transmit queue 305 with additional frames F3, F4, F5 and F6 with frame F4 being a QM frame as shown at 1219. In this case, the marked frame F4 is intended to be the first frame transmitted during interval I2. Since, at the start of the interval I2 no QM frame has been encountered since the start of the interval I1, the QM logic 801 knows that any unmarked frames at the head of the queue were leftover from or submitted too late for transmission during the interval I1 and should not be transmitted during the interval I2. Accordingly, the frame F3 is such a frame at 1217 and is dropped rather than being transmitted during interval I2. Instead, the MAC device 223 first drops unmarked frames until detecting the marked frame, which is this case (i.e. F4 at 1219). The MAC device 223 transmits frame F4 as shown at 1221 . Operation proceeds in this manner with the recipient of frame F4 acknowledging it via an ACK frame at 1223, and frames F5 and F6 being transmitted as shown at 1225 and 1229, respectively confirmed by corresponding ACK frames as shown at 1227 and 1231. In this manner, it is appreciated that the frame F3 is dropped rather than being transmitted during the interval I2. As discussed above, the fact that frame F3 was dropped may or may not be reported to the network I/O driver 219, depending on the status reporting specified in its frame delimiter.

It is noted that QM operation may be enabled or disabled. In one embodiment, QM operation is enabled automatically when the transmission scheduler 307 encounters a QM frame. Once enabled, QM operation continues while QM frames continue to be detected. QM operation is automatically disabled when a predefined number of intervals have elapsed without a marked frame. In one embodiment, for example, the MAC device 223 disables QM operation when no marked frame has been detected for two consecutive intervals as may be programmed by the host system.

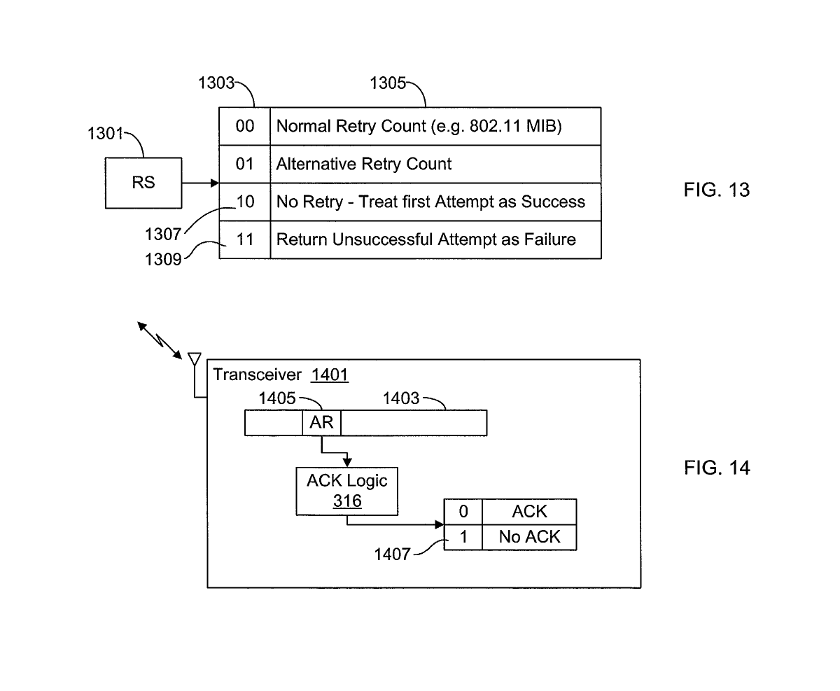

FIG. 13 is a tabular diagram illustrating the retry strategy programmed within the RS field, shown at 1301, of a frame descriptor of a frame. In the embodiment shown, the RS field 1301 is a two-bit field providing up to four different operational variations corresponding to the four binary values “00”, “01”, “10” and “11” in tabular format shown at 1303. The corresponding programmed operation is shown at 1305 in tabular format. In conventional operation, any frame that is not successfully received is typically retried either until it is acknowledged or until a specified number of attempts have been made. In an 802.11 network, for example, this retry count is specified in an 802.11 management information base (MIB) entity that contains the maximum number of times that a transmission is to be retried before being dropped. There may also be a specified transmit lifetime or retry time duration that is a total elapsed time after which an unacknowledged frame is dropped. In conventional MAC devices only those MIB values are available to control retries, and they apply uniformly to all outgoing frames. As shown at 1303 in tabular format, a “retry strategy” field is included where a program value of “00” binary indicates a standard or normal retry count according to a normal retry strategy for the particular protocol being employed. For 802.11, for example, the 802.11 MIB is consulted to determine a normal retry count. A normal retry count denotes a relatively universal number of retries for each frame unless otherwise specified.

If the RS field 1301 is programmed with a “01” binary, an alternative retry count is used instead. In this case, a different or alternative count value may be utilized for this particular frame, so that it is retried by the same or different number of times as the normal retry count, depending upon the programmed alternative retry count value. This provides the benefit in that the host software may program a different alternative retry count and program specific frames to be retried according to the alternative retry account rather than the normal retry count specified in the 802.11 MIB. For example, a significantly smaller retry count may be employed for latency sensitive frames. As shown at 1307, the RS field 1301 may further be programmed with a “10” binary to specify that the first attempt is treated as a successful attempt and retries are not attempted. In particular, the MAC device 223 attempts to transmit the frame once and does not attempt to retry the frame regardless of whether an ACK frame is received by a receiving device. The “No-Retry” strategy is useful because there may be frames which have no reason to be returned, and for which it is wasteful to consume time on the wireless medium 106 sending a retry that will not be used even if it were to be received successfully.

For example, in many streaming video applications, if a frame is not received successfully the first time, there is no benefit to retry the frame since it will be too late for the frame information to be displayed by the time the retry could occur. It is better to not delay the next frame of video information. Thus, it is desirable to transmit the next frame since the receiving device is then ready to display the next frame. The higher-level application programs 218 and/or the network I/O driver 219 programs the RS field 1301 of such frames with “No Retry” to prevent the MAC device 223 from retrying the frame. An additional benefit may be obtained if the “No Retry” strategy is signaled with the frame transmitted to the receiving device, so that the recipient knows not to send the ACK frame in such cases. If this is done the transmitting device need not wait to receive an ACK frame and may, if allowed by the MAC protocol, immediately commence with the transmission of the next frame. The optional elimination of ACK frames enables increased and more efficient utilization of the wireless medium.

The RS field 1301 may further be programmed with “11” binary as shown at 1309 for which a return unsuccessful attempt is interpreted as a failure. In this case, the MAC device 223 attempts to transmit the frame only once and if the frame is not acknowledged with an ACK frame, the MAC device 223 reports back to the network I/O driver 219 that the frame transmission was unsuccessful. Thus, the frame is attempted only once and not retried. If an ACK frame is not received, the failure is reported back to the network I/O driver 219.

As described previously, the TX frame manager 303 detects the RS field of the frame descriptor for a frame and determines whether to retry an unacknowledged frame, and if so, how many times. It is appreciated that this first aspect of the retry strategy may be wholly contained within a transmitting device regardless of the configuration of the receiving device. The retry logic 308 may optionally program at least one acknowledgement request bit in the frame to be transmitted to inform the receiving device of the retry strategy employed by the transmitting device. The receiving device, however, may not be configured to detect the acknowledgement request bit in the successfully received frame. If the receiving device is not configured to detect the acknowledgement request, it will respond with an ACK frame by default in accordance with standard protocol procedure to acknowledge the successfully received frame regardless of the status of the acknowledgement request bit in the received frame. For example, if the duration/ID field is employed for indicating the retry strategy or an acknowledgement request, the programmed bits are transparent to standard receiving devices, which are not configured to check these bits. If the receiving device is configured to detect the acknowledgement request bit in the received frame, then a second aspect of the retry strategy may be used. In this second aspect, the receiving device does not send an ACK in response to a successfully received frame if the acknowledgement request bits indicate a “No Retry” policy for that frame. It is appreciated that the retry strategy is selectable on a frame-by-frame basis.

FIG. 14 is a simplified block diagram of a transceiver 1401 that is configured to detect a selectable acknowledgement request in successfully received frames. As described previously, in one embodiment at least one of the bits of the duration/ID field is employed for this purpose, although other methods are possible and contemplated. For example, a separate QoS control field may by employed to convey retry strategy information. The transceiver 1401 has successfully received a transmitted frame 1403 with a selectable acknowledgement request (AR) bit as shown at 1405. As described previously, the retry logic 308 programs the frame in accordance with the retry strategy defined within the RS field of the frame descriptor of the frame. In the embodiment shown, the acknowledgement request bit is set or programmed to a logic “1” binary if the RS field was programmed with “01” binary indicating “No Retry” and is reset or programmed to a logic “0” binary for any other retry strategy. As described previously, at least one acknowledgement request bit of the transmitted frame is optionally programmed to indicated the applicable retry strategy. Of course, additional bits may be employed, such as, for example, the same two bits of the RS field of the frame descriptor to convey the retry strategy for the frame. The transceiver 1401 includes ACK logic 316, similar to that shown at FIG. 3, which reviews the acknowledgement request bit(s) 1405 in successfully received frames and determines whether to send an ACK frame. If the acknowledgement request bit 1405 is “0”, then the ACK logic 316 informs the transceiver 1401 to transmit an ACK frame to indicate that the frame was successfully received. If the acknowledgement request bit 1405 is programmed with “1”, however, as shown at 1407, then the ACK logic 316 determines that an ACK frame should not be transmitted (No ACK) since the transmitting device has indicated “No Retry”. In this manner, if the acknowledgement request bit of a frame is marked as “No ACK”, then the receiving device does not respond with an ACK frame, which allows a greater proportion of the bandwidth of the wireless medium 106 to be used for data, since less is consumed by control frames.

The selective suppression of ACK frames enables streamlined and more efficient data transfer operation in that frames may be transmitted in sequence without wasting time on the wireless medium switching from transmitting to receiving and waiting for the interspersed ACK frames.

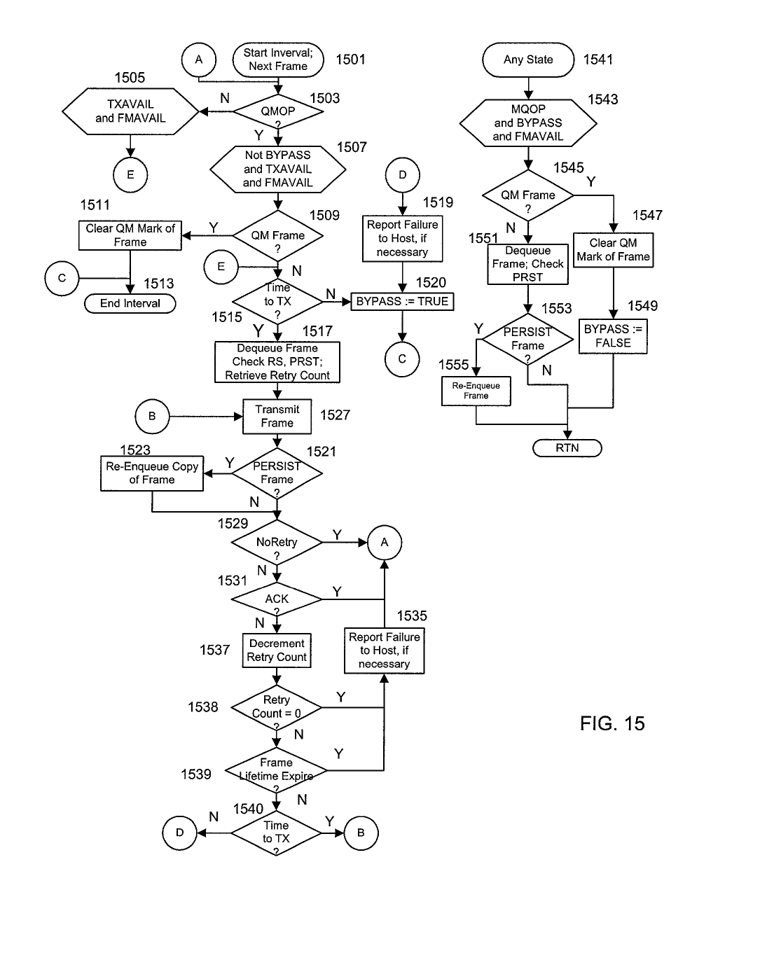

FIG. 15 is a flowchart diagram of an exemplary routine of the transmission scheduler 307 illustrating partial operation of the MAC device 223 for processing frames within any of the transmit queues 305. In one exemplary embodiment, for example, a primary routine (not shown) calls the illustrated routine while designating a particular one of the transmit queues 305 for processing frames within that queue. It is understood that the operation illustrated in the flowchart is not intended for specific configurations, but instead is generalized in nature to be used as a guideline for particular configurations based on the wireless protocols employed. The specific blocks illustrated are intended to describe logical functions in general and not necessarily in the order or manner portrayed. It is understood that multiple routines or threads may be activated at appropriate times, such as within appropriate timing constraints, and are not necessarily performed in the particular sequence illustrated.

A first block 1501 represents the start of an interval or the processing of a next frame in a given transmit queue 305. Operation proceeds to next decision block 1503 to query QMOP, which is a global variable set by the primary routine or another sub-routine or the like of the transmission scheduler 307 if QM operation is enabled and active. QM operation may be enabled and disabled by a register value or bit, which may be programmed by the network I/O driver 219 or other software or firmware. QM operation may further be active or not active even while enabled. Automatic activation operation is contemplated, in which QM operation is activated upon detection of a QM frame and deactivated after two or more consecutive intervals have elapsed without detection of a QM frame.

If QMOP is TRUE as determined in decision block 1503, operation proceeds to next block 1507, which contains a conditional expression that must become TRUE before operation proceeds to subsequent operational blocks. It is noted that overall operation is not necessarily paused if other conditions are detected, such as, for example, if another routine is activated by a different conditional expression or if a priority signal is detected, etc. In block 1507, the variables BYPASS, TXAVAIL and FMAVAIL are queried to determine if and when operation proceeds. The variable BYPASS generally indicates the QM state in which frames are to be bypassed or otherwise dropped in accordance with QM operation. The variable TXAVAIL indicates whether the wireless medium 106 is available for transmission of a frame, where TXAVAIL may be set by the access and response logic 317 if the clear channel assessment function of the radio 225 indicates that the wireless medium 106 is not in use and available for transmitting a frame. The variable FMAVAIL indicates whether the relevant transmit queue 305 has a frame available for transmission and is not physically empty.

If BYPASS is FALSE (e.g., if Not BYPASS=TRUE), and if TXAVAIL and FMAVAIL are both TRUE, then operation proceeds from block 1507 to decision block 1509 at which the QM field of the next frame in the relevant transmit queue 305 is examined to determine if the frame is a QM frame and the ACK response if the frame type and retry strategy require an ACK frame. If the frame is not a QM frame as determined at decision block 1509, then operation proceeds to next decision block 1515 at which it is determined whether there is sufficient time in the current interval to transmit the frame. In one embodiment, a process, procedure or other routine is called to determine the difference between the elapsed time of the interval and the maximum time allocated for the interval and the amount of time that is necessary to transmit the frame at the particular data rate and encoding appropriate for the transmission. Referring back to decision block 1503, if QMOP is FALSE such that QM operation is not active, then operation proceeds instead to block 1505 containing a conditional expression that is TRUE if the variables TXAVAIL and FMAVAIL are both TRUE regardless of the state of BYPASS. If so, operation proceeds directly to decision block 1515 bypassing blocks 1507 and 1509.

If there is sufficient time to transmit the frame as determined at decision block 1515, then operation proceeds to block 1517 at which the frame at the head of the relevant transmit queue 305 is dequeued. The RS field of the retrieved frame and the PRST field (or otherwise the persistent bit) are checked to identify the appropriate processing for the frame, and the appropriate retry count for the frame is retrieved if necessary. As described previously, if the RS field is “00” binary, then the normal retry count is retrieved from the MIB, host interface register, frame descriptor or other location as may be appropriate, and if the RS field is “01” binary, then the alternative retry count is retrieved. For other RS values, a retry count is not necessary. Operation then proceeds to block 1527 from block 1515 to attempt transmission of the frame. As noted previously, transmission and re-enqueuing operations may be considered independent operations and it is not intended that they be performed in any particular order. In one embodiment, a transmit procedure or the like (not shown) is called to attempt transmission. As described previously, transmission of the frame may not be successful given the dynamic and unpredictable character of the wireless medium. At next decision block 1521, it is determined whether the frame is a persistent frame. If the frame is not persistent, operation proceeds to next block 1529, described below. If the frame is persistent as determined at decision block 1521, operation proceeds instead to block 1523 at which a copy of the frame is re-enqueued at the end of the relevant transmit queue 305. Operation then proceeds to block 1529 from block 1523.

At decision block 1529, after attempted transmission, it is queried whether the RS field of the frame descriptor of the frame indicated a “No-Retry” frame for which a retry is not to be attempted and in which the first transmit attempt is treated as successful. In that case, operation returns to decision block 1503 for processing the next frame in the relevant transmit queue 305 because the current frame is not retried and the MAC device 223 further does not need to verify whether an ACK frame was sent by the receiving device. Otherwise, operation proceeds to decision block 1531 at which it is determined whether an ACK frame was received from the receiving station within the applicable acknowledgement period defined by the communication protocol. If so, then the transmission of the frame was successful and operation returns to decision block 1503 for processing the next frame in the relevant transmit queue 305. Otherwise, if an ACK frame was not received indicating that the frame was not successfully received, operation proceeds to block 1537 to decrement the retry count, and then to block 1538 to determine if the retry count has been decremented to zero. Transmission is retried, for example, if the RS field of the frame is “00” or “01” binary indicating a retry count and the retry count is not zero. Transmission is not retried, for example, if the RS field of the frame is “11” binary indicating that the unsuccessful attempt is treated as a failure. It is noted that in either cases it may be appropriate to indicate to the host system whether the frame reception was successful, and if not, any conditions associated with transmission failure, such as a number of unsuccessful retry attempts or expiration of the frame lifetime.

If the retry count has been decremented to zero as determined at decision block 1538, then operation proceeds to block 1535 at which the failure is reported to the network I/O driver 219 if necessary. Such reporting is facilitated via the TX done queue 319 or any other reporting feedback path or mechanism. It is noted that successful transmission may also be reported if such reporting is indicated by the host system. From block 1535, operation returns to block 1503 to begin processing of the next frame. If the retry count is not zero as determined at decision block 1538, then operation proceeds to block 1539 to determine if the frame lifetime of the frame, if specified, has expired. If the frame lifetime has been specified and has expired, then operation proceeds to block 1535 previously described. If the frame lifetime has not been specified or has not expired, then operation proceeds instead to decision block 1540 at which it is determined if there is sufficient time to retry transmission of the frame in a similar manner as described above for decision block 1515. If there is sufficient time in the interval for a retry transmission, then operation returns to block 1527 to attempt a retry transmission of the frame. Operation loops between blocks 1527 and 1540 until transmission is successful as indicated by reception of an ACK frame at block 1531, or until the retry count becomes zero at block 1538, or until the frame lifetime, if specified, has expired as determined at block 1539, or until there is insufficient time in the interval to retry transmission of the frame as determined at decision block 1540.

Referring back to decision block 1515, if there is insufficient time for transmission, operation proceeds to block 1520 at which the BYPASS variable is set to TRUE. It is noted that BYPASS is set TRUE even though the next frame, if any, in the relevant transmit queue 305 has not been examined for QM operation in the event there is insufficient time to retry transmission of a frame. As described further below, this case is handled by a different portion of the routine. After BYPASS is set TRUE at block 1520, operation proceeds to block 1513 at which appropriate functions are performed or called to end the current interval. Also, if there is insufficient time for retry transmission as determined at decision block 1540, then operation proceeds to block 1519 at which failure of transmission, or failure of re-transmission, is reported back to the network I/O driver 219, if necessary, in a similar manner as described above for block 1535. In this case such reporting may include a distinction between “failed due to retry count” and “failed because time ran out prior to using all of the allowed retries.” The frame is effectively dropped (with respect to transmission) and the network I/O driver 219 determines further processing, if any, to recover from failure to transfer the frame successfully.

Referring back to decision block 1509, if the frame is a QM frame, operation proceeds instead to block 1511 at which the QM bit (or the QM field) of the frame is cleared to remove the QM indication in the corresponding frame descriptor. In this manner, the marked frame remains as the first frame from the relevant transmit queue 305 to be transmitted in the next interval but is not still marked when this next interval begins. From block 1511, operation proceeds to block 1513 to end the current interval as previously described. In general operation, as many non-QM frames as possible are transmitted from the relevant transmit queue 305 until there is insufficient time to transmit a frame or until a QM frame is encountered or until the routine is temporarily halted in favor of a higher priority transmit queue 305. If QMOP is FALSE indicating that QM operation is not active, then the MAC device 223 transmits as many frames as possible from the relevant transmit queue 305 in the current interval. The flowchart may be modified to automatically activate QM operation and set QMOP to TRUE in the event a QM frame is received while QM operation is otherwise enabled. For example, in an alternative embodiment, if QMOP is FALSE as determined at decision block 1503, then additional blocks are added to determine if the frame is nonetheless a QM frame. If the frame is a QM frame, then QMOP is set TRUE and operation returns back to block 1507 so that QM operation is automatically activated.

An “Any State” block 1541 is provided generally indicating that when the conditional expression in the following block 1543 is TRUE, operation proceeds to decision block 1545 from any of the states 1501-1540 previously described. The conditional expression of block 1543 becomes TRUE when the QMOP, BYPASS and FMAVAIL variables are all TRUE. This conditional expression is in contrast to that of block 1507 at which BYPASS must be FALSE. When the conditional expression of block 1543 becomes TRUE, operation proceeds to decision block 1545, at which it is queried whether the current frame is a QM frame. If the frame is a QM frame, then operation proceeds to block 1547 in which the QM mark or bit is cleared and then to next block 1549 in which the BYPASS variable is set FALSE. Operation then returns (RTN) to whichever block 1501-1540 was active and interrupted when the expression of block 1543 became TRUE. Alternatively, if the frame is not a QM frame as determined at decision block 1545, then operation proceeds instead to block 1551 at which the frame is dequeued from the relevant transmit queue 305 and the PRST field of the frame is checked. If the frame is a persistent frame, operation proceeds to block 1555 at which the frame is re-enqueued at the end of the relevant transmit queue 305. If the frame is not a persistent frame, or after determining that the frame is to be re-enqueued, then operation returns to one of the blocks 1501-1540. In this manner, if the frame is not a QM frame (QM operation) during bypass operation in blocks 1541-1555, then the frame is retrieved from the transmit queue and effectively dropped. If the frame is a persistent frame, it is re-enqueued for a subsequent interval even though dropped in the current interval.

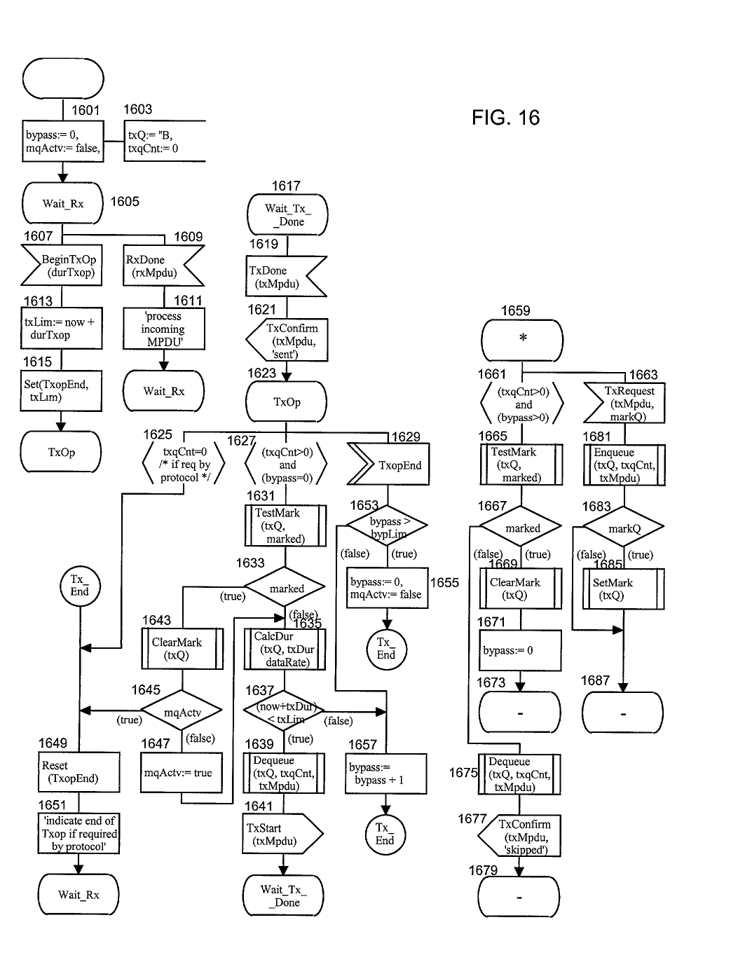

FIG. 16 is a process diagram illustrating further details of an exemplary QM operation for 802.11-style protocols. The process diagram is a formal specification of an extended finite state machine in the ITU Specification and Description Language (SDL) as defined in ITU-T Recommendation Z.100-1996 (ITU: International Telecommunications Union). At a first task symbol 1601, state variables are initialized. In particular, an integer variable “bypass” is set to zero and a Boolean variable “mqActv” is set to FALSE. The “bypass” variable is similar to that described previously, where bypassing is not active when “bypass” is zero and is activate when “bypass” is greater than zero. The use of a bypass integer rather than a Boolean facilitates automatic activation or deactivation of QM operation as further described below. QM operation is assumed to be enabled, and the “mqActv” variable specifies whether QM operation is active. Also, a text extension symbol 1603 indicates that the transmit queue 305 “txQ” is initialized to be empty and the number of frames, or frame count “txqCnt”, in the queue is set to zero. receive function 313 The process then enters state “Wait_Rx” at 1605 until the occurrence of either an “RxDone” or a “BeginTxOp” event. When the receive subsystem 225 completes the reception of a valid frame addressed to this station, the signal “RxDone” a transition is initiated at 1609 to process the incoming MPDU 1611 in a manner appropriate for the MAC protocol in use, after which the transition terminates back at the “Wait_Rx” state 1605. Because receive processing is not relevant to the present invention, further details of incoming MPDU handling are omitted.

When a transmission opportunity (TxOp) for this station begins, signal “BeginTxOp” at 1607 initiates a transition to perform MPDU transmission . This TxOp may be initiated based on internally generated criteria, such as the beginning of a protocol-defined interval, or based on received information, such as a poll frame from a control station. In the case of the IEEE 802.11 WLAN protocol, an example the first case is the start of a CFP based on the occurrence of a target beacon transmission time (TBTT) as detected by the time synchronization function (TSF) timer at the AP. An example of the second case is the detection of a CF-poll function in a frame received by this station from the AP of its Basic Service Set (BSS). In either case the TxOp is an interval with a defined starting time and a defined (maximum) duration.

The “BeginTxOp” signal at 1607 includes a parameter “durTxop”, which contains the duration of the transmission interval for this station. In task symbol 1613, a variable “txLim” is assigned to the time by which the transmit opportunity TxOp must end, which is the current time “now” plus “tdurTxOp”. Then in task 1615, a timer “TxopEnd” is started so that a “TxOpEnd” signal will occur when “now” is equal to “txLim”. The transition ends at state “TxOp” 1623.

When in state “TxOp” 1623, transitions may be initiated by any of enabling conditions 1625 and 1627 or by signal “TxOpEnd” at 1629. Enabling condition 1625 ends the current TxOp when the relevant transmit queue 305 is empty, as indicated by variable “txqCnt”, which holds the number of FDs on the queue, is zero. Enabling condition 1625 initiates an optional transition which is used for protocols in which it is desired to end the TxOp early due to lack of traffic. If so, operation proceeds to task 1649 in which the timer TxopEnd is reset, and then to task 1651 in which the end of the current TxOp is indicated if required by the particular protocol. For example, if this transition were used in an 802.11 AP for the CFP, the indication of end would be transmission by the AP of a CF-End control frame. The current TxOp then ends and the station returns to state “Wait_Rx” 1605.

Enabling condition 1627 provides frame handling during a TxOp when the transmit queue 305 is not empty (because txqCnt>0) and bypassing is not enabled (variable “bypass” is zero). The transition starts by invoking procedure “TestMark” 1631, which determines if a QM mark is present “in front” of the first MPDU in the transmit queue 305 (named “txQ” in this case). In these embodiments, the frame of FD includes a QM bit or the like for the frame or a separate queue element that represents the mark. The TestMark procedure sets the Boolean variable “marked” to TRUE if a queue marker is in front of the first MPDU or in the frame descriptor of the first MPDU in the transmit queue 305, and otherwise sets “marked” to FALSE. At next decision 1633, the value of “marked” is tested. If “marked” is FALSE, operation proceeds to procedure call 1635, which invokes a procedure “CalcDur” to calculate the duration required to transmit the MPDU at the head of the transmit queue 305 (txQ) at the data rate specified by variable “dataRate”. Then decision 1637 tests whether there is sufficient time to transmit this MPDU before the end of the current TxOp. If so, operation proceeds to procedure call 1639, which invokes a “Dequeue” procedure to remove the first FD on the transmit queue 305 and place it into variable “txMpdu” and to decrement the frame count “txqCnt” of the transmit queue 305. Then output symbol 1641 initiates MPDU transmission by sending signal “TxStart” with parameter “txMpdu”. The transition then terminates at state “Wait_Tx_Done” 1617 which waits until the current frame is transmitted. When transmission of the frame “txMpdu” is completed, the transmitter sends signal “TxDone”, which is received at input symbol 1619 to exit state “Wait_Tx_Done” 1617. The transition proceeds to output symbol 1621, where a “TxConfirm” signal is sent to inform the host network driver that “txMPDU” has been sent. The transition terminates in state “TxOp” 1623 previously described.

Referring back to decision 1633, if the value of “marked” is TRUE, the transition proceeds to procedure call 1643 which invokes a “ClearMark” procedure to clear or otherwise remove the QM mark from in front of the first MPDU descriptor in the transmit queue 305. The transition then proceeds to decision 1645, which tests the “mqActv” Boolean variable. If the value of “mqActv” is FALSE, the transition proceeds to task 1647 where the value of “mqActv” is set to TRUE. This causes the first mark found while QM operation is not active to result in the activation of QM operation. The transition then proceeds to procedure call 1635, previously described, which invokes “CalcDur” to calculate the time required to transmit the MPDU. If the value of “mqActv” is TRUE when tested at decision 1645, the transition instead proceeds to tasks 1649 and 1651, previously described, to end the current TxOp interval.

Referring back to “TxOp” 1623, any occurrence of a signal “TxOpEnd”, which indicates time out of the TxOpEnd timer set in task 1615, initiates the transition below priority input 1629. This signal takes precedence over any other signals already on the process input queue because of the priority input signal 1629. This timeout indicates that interval for the current TxOp has ended. The transition as indicated at 1629 proceeds to decision 1653 to determine if the value of the “bypass” counter is greater than the current limit value “bypLim”. This situation can occur only when there have been no MPDUs for the entire TxOp. If the value of “bypass” has exceeded the limit “bypLim”, then the transition proceeds to task 1655 to set “bypass” back to zero and to set “mqActv” to FALSE which automatically inactivates QM operation until the next QM mark is encountered. In this manner, QM operation is automatically inactivated if a number “bypLim” of TxOp intervals (typically 2) elapse without encountering a QM frame. The variable “bypLim” may be fixed or programmable in any desired manner, such as by the host system. The transition then proceeds to tasks 1649 and 1651, previously described, to end the current TxOp interval. If the value of “bypass” is not greater than “bypLim” as determined at decision 1653, then the transition proceeds instead to task 1657 at which the value of “bypass” is incremented by 1, after which the transition continues to tasks 1649 and 1651, previously described, to end the TxOp interval. This results in the “bypass” counter holding a count of TxOp intervals which ended by timeout, which can only exceed 1 if no transmissions or QM marks occur for an entire interval.

Asterisk state 1659 indicates the start of transitions that may occur from any other state (1605, 1617, 1623) previously described when either the enabling condition 1661 or input signal 1663 are detected. Enabling condition 1661 occurs when the transmit queue frame count “txqCnt” is greater than zero indicating at least one MPDU is in the transmit queue 305 and bypassing is active as shown by the value of “bypass” being greater than zero, initiating a transition to procedure call 1665 where the procedure “TestMark” is invoked to determine if a QM mark is present in front of the first MPDU in the transmit queue 305, and then to decision 1667 to test the “marked” variable returned by “TestMark”. If “marked” is TRUE, the transition proceeds to procedure call 1669 which invokes the procedure “ClearMark” to remove the QM mark, and then to task 1671 to set the value of “bypass” back to zero thereby turning bypassing off. The transition then ends in the same state that it began as indicated by dash Nextstate 1673. If the value of “marked” is TRUE at decision 1667, then transition proceeds to procedure call 1675 which invokes the Dequeue procedure to remove the next MPDU from the transmit queue 305 and decrement the count of MPDUs on the queue, “txqCnt”. At output 1677, a TxConfirm signal is sent to inform the network driver software that the MPDU was not transmitted but instead bypassed the transmit function 309 and was “skipped” or otherwise dropped. The transition then ends in the state from which the transition began as indicated by dash Nextstate 1679.

When a new MPDU has been submitted for transmission, signal “TxRequest” is received from the network driver software or intermediate functions in the interface to the host computer. This signal initiates a transition at input 1663 which proceeds to procedure call 1681 to invoke procedure “Enqueue” which adds the new MPDU to the end of the transmit queue 305 and increments the count of MPDUs on the queue “txqCnt”. The transition then proceeds to decision 1683 which tests a variable “markQ” which was set by input 1683 from signal “TxRequest” to indicate a request to insert a QM mark ahead of the new MPDU. If the value of “markQ” is TRUE, the transition proceeds to procedure call 1685 which invokes a “SetMark” to insert a QM mark in front of the just enqueued MPDU in the transmit queue 305 or the set the mark indicator in the descriptor of that MPDU. The transition ends in the same state it began as indicated by dash Nextstate 1687. Otherwise, if the value of “markQ” is FALSE when tested at decision 1683, the transition immediately ends in the original state via dash Nextstate 1687.

The SDL process of FIG. 16 handles most if not all processing depending upon when the QM mark is detected for many different configurations and implementations. In Access Point configurations according to the IEEE 802.11 standard, for example, the specific processing depends on whether the QM mark is detected before or after the end of the CFP of the current Superframe. If the QM mark is detected during transmit queue processing within the CFP, then no further traffic is available for transmission during the current CFP, so that the MAC 223 transmits a CF-End{+ACK} frame as its “indicate end of TxOp” at 1651. The QM mark bit in the TX Control field 405 at the end of the transmit is cleared and processing of that transmit queue 305 is suspended until after the Beacon at the beginning of the next Superframe, with the previously marked frame remaining at the head of the transmit queue 305. If the transmit queue 305 becomes empty during the CFP but prior to detection of the QM mark, transmissions in the BSS cease until another frame is available on the transmit queue 305 or until the CFP is forced to end because CFPMaxDuration is reached. If there is an ACK frame pending for a received frame when the end of the transmit queue 305 is reached, a Null+CF-Ack frame is generated by the MAC 223.

When CFPMaxDuration has elapsed since TBTT, or if there is not sufficient time remaining until CFPMaxDuration to accommodate the duration calculated for the frame at the head of the transmit queue 305, the AP indicates the end of the CFP with transmission of a CF-End{+ACK} frame generated by the MAC 223. Until detection of a QM frame, any unmarked frames encountered on the transmit queue 305 bypass the transmit function 309, moving directly from the transmit queue 305 to the TX done queue 319 with a status bit indicating that the frame was not delivered (skipped) at the end of the CFP. The bypassing includes unmarked frames already on the transmit queue 305 at the end of the CFP, and unmarked frames enqueued after the end of the CPF but before a QM frame. In cases where the network 1/0 driver 219 does not submit the appropriate QM frame until after TBTT of the next Superframe, this bypassing may extend into the next Superframe period. In the TxDone process, a frame with a marked status bit indicating that the frame was not delivered at the end of the CFP is considered an exception, so these frames are either reported back to the network I/O driver 219 or discarded (dropped) based on another control bit in the frame descriptor.

If a QM frame is detected in the transmit queue 305 while bypassing frames after the end of the CFP and before the Beacon at the start of the next Superframe, then bypassing operation ceases. The QM field of the frame at the head of the transmit queue 305 is cleared and processing of the transmit queue 305 is suspended until after the Beacon at the beginning of the next Superframe, with the previously marked frame remaining at the head of the transmit queue 305 so as to be the first frame transmitted after the beacon. In cases where the Beacon frame is transmitted at the start of a Superframe while processing from the transmit queue 305 is suspended due to previous detection of a QM frame, processing of the transmit queue 305 resumes at the end of the Beacon frame. Because the mark was cleared at the time queue processing was suspended, the frame at the head of the transmit queue 305 is no longer marked and is handled normally. In cases where the Beacon frame is transmitted at the start of a Superframe but no QM frame has been detected, the bypassing continues, and transmissions cease at the end of the Beacon frame with the CFP continuing. When a QM frame is detected at the head of the transmit queue 305, the bypassing ceases, the mark is cleared and the previously marked frame is transmitted normally. This case may occur due to excessive delays in host interrupt response, frame processing by background tasks on the host computer system, and/or other time variables of the variable interface 105. If the entire CFP duration elapses without detecting a QM frame, QM operation becomes inactive (based on bypass limit=1). This allows the host software to cease submitting any frames during periods of inactivity and to have QM processing automatically resume with transmissions synchronized to the beginning of the next Superframe. This has the further advantage that the host software does not have to track the inferred bypass state of the MAC, so there is not risk that the actual inferred states will be inconsistent.

Although a system and method according to the present invention has been described in connection with one or more exemplary embodiments, it is not intended to be limited to the specific form set forth herein, but on the contrary, it is intended to cover such alternatives, modifications, and equivalents, as can be reasonably included within the spirit and scope of the invention as defined by the appended claims. For example, although the present invention has been illustrated as employed for wireless communications, it is understood by those skilled in the art the it may be applied in general to any network configuration, including wired networks.

1. A method by a transmitter for processing frames in a FIFO transmit queue during each of successive transmission intervals, the frames received across a variable delay interface from a scheduler system, comprising:
detecting frames enqueued into the transmit queue;
detecting marked frames that are marked as transition frames as compared to unmarked frames;
for each allowed transmission interval while bypassing is not active, dequeuing and transmitting enqueued unmarked frames during an interval until there is insufficient time remaining in the interval to transmit another frame or until a marked frame is detected during the interval;
during each allowed transmission interval while bypassing is not active, ending transmission from the transmit queue when a marked frame is detected; and
while bypassing is active, dropping enqueued unmarked frames until a marked frame is detected.

2. The method of claim 1, further comprising:
if an enqueued marked frame is detected, clearing a mark of the marked frame so that the frame becomes an unmarked frame.

3. The method of claim 2, further comprising
activating bypassing if a marked frame has not been detected during an interval; and
if a marked frame is detected while bypassing is active, clearing a mark of the marked frame so that it becomes an unmarked frame and deactivating bypassing.

4. The method of claim 1, further comprising:
enabling queue mark operation if a marked frame is detected while queue mark operation is not active;
incrementing a bypass variable each time an interval ends without detecting a marked frame; and
disabling queue mark operation if the bypass variable reaches a bypass limit.

5. The method of claim 4, further comprising:
ending transmissions during an interval upon detecting a marked frame during the interval while queue mark operation is active or upon timeout of the interval or if there is insufficient time in the interval to transmit another frame.

6. The method of claim 5, further comprising:
transmitting an end of interval frame to end the interval early.

7. The method of claim 5, further comprising:
ceasing transmissions in order to end the interval early.

8. The method of claim 5, further comprising:
ceasing transmissions early by sending a frame with a control field that indicates final transmission.

9. The method of claim 4, upon detecting a marked frame while queue mark operation is not enabled, further comprising:
clearing a mark of the marked frame so that the frame becomes a previously marked frame;
transmitting the previously marked frame if there is sufficient time remaining in a current interval; and
incrementing the bypass variable if there is insufficient time remaining in the current interval to transmit the previously marked frame.

10. The method of claim 4, further comprising:
setting the bypass variable to zero if queue mark operation is disabled because the bypass variable had reached the bypass limit.

11. The method of claim 1, further comprising:
reporting to the scheduler system whether a frame was successfully transmitted.

12. A method of synchronizing data transmission between a computer system and a transmitter across a variable interface with variable delay and latency, comprising:
marking, by the computer system, transition frames between successive transmission intervals;
transferring, by the computer system, consecutive frames across the variable delay interface to the transmitter, the consecutive frames including any marked frames;
enqueuing, by the transmitter, the frames transferred via the variable delay interface into a FIFO transmission queue;
detecting, by the transmitter, marked frames that are marked as transition frames as compared to unmarked frames;
ending, by the transmitter during each interval while bypassing is not active, enqueued unmarked frames until the interval times out or until there is insufficient time remaining in the interval to transmit another frame or until a marked frame is detected;
terminating, by the transmitter during each interval while bypassing is not active, transmission from the transmit queue when a marked frame is detected; and
dropping, by the transmitter while bypassing is active, enqueued unmarked frames until a marked frame is detected.

13. The method of claim 12, further comprising:
clearing, by the transmitter if an enqueued marked frame is detected, a mark of the marked frame so that the frame becomes an unmarked frame.

14. The method of claim 13, further comprising
activating, by the transmitter, bypassing if a marked frame has not been detected during an interval; and
deactivating, by the transmitter, bypassing if a marked frame is detected while bypassing is active.

15. The method of claim 14, further comprising:
enabling, by the transmitter, queue mark operation if a marked frame is detected while queue mark operation is not enabling;
incrementing, by the transmitter, a bypass variable each time an interval ends without detecting a marked frame; and
disabling, by the transmitter, queue mark operation if the bypass variable reaches a bypass limit.

16. The method of claim 15, further comprising:
ending, by the transmitter, an interval upon detecting a marked frame during the interval while queue mark operation is enabling or upon timeout of the interval or if there is insufficient time in the interval to transmit another frame.

17. The method of claim 15, further comprising:
clearing, by the transmitter upon detecting a marked frame while queue mark operation is not enabled, a mark of the marked frame so that the frame becomes a previously marked frame;
transmitting, by the transmitter, the previously marked frame if there is sufficient time remaining in a current interval; and
incrementing, by the transmitter, the bypass variable if there is insufficient time remaining in the current interval to transmit the previously marked frame.

18. The method of claim 15, further comprising:
setting, by the transmitter, the bypass variable to zero if queue mark operation is disabled because the bypass variable had reached the bypass limit.

19. The method of claim 12, further comprising:
indicating, by the computer system, whether to report transmission status of a frame; and
reporting, by the transmitter to the computer system, whether the frame was successfully transmitted or dropped.

20. A computer system configured for wireless communications across a wireless medium, comprising:
a scheduler that transfers frames for transmission via an interface with variable delay and latency;
the frames including marked frames that are each intended for transmission as a first frame of a selected interval of successive transmission intervals;
a transmitter, coupled to the variable interface of the scheduler, that enqueues frames received via the variable interface into a FIFO transmission queue, that transmits unmarked frames for each interval until the interval times out or until there is insufficient time remaining in the interval to transmit another frame or until a marked frame is detected during the interval while bypassing is not active; and
the transmitter ending transmission from the transmit queue when a marked frame is detected during the interval while bypassing is not active, and dropping unmarked frames until a marked frame is detected while bypassing is active.

21. The computer system of claim 20, wherein the scheduler further comprises:
a memory system that stores software including an operating system, a wireless application and a host driver;
a processor, coupled to the memory, that executes software from the memory system including the operating system, the wireless application and the host driver; and
a bus system coupled to the memory system and the processor.

22. The computer system of claim 20, wherein the transmitter further comprises:
a host interface;
at least one FIFO transmit queue;
a transmit frame manager, coupled to the host interface and the at least one FIFO transmit queue, that enqueues frames received via the variable interface into a selected FIFO transmission queue;
an antenna;
a transmitter coupled to the antenna for sending and receiving frames; and
a transmission scheduler, coupled to the transmitter and the at least one FIFO transmit queue, that processes enqueued frames.
